(19) United States
(12) Patent Application Publication
(10) Pub. No.: US 2026/0027522 A1
(43) Pub. Date: Jan. 29, 2026

(54) INCREASING FLOW RATE IN ELECTRODEIONIZATION DEVICES

(71) Applicant: Evoqua Water Technologies LLC, Pittsburgh, PA (US)

(72) Inventors: Jacob Telepciak, Littleton, MA (US); Li-Shiang Liang, Harvard, MA (US); Frederick C. Wilkins, Pepperell, MA (US); Gary C. Ganzi, Lexington, MA (US)

(21) Appl. No.: 18/781,051

(22) Filed: Jul. 23, 2024

Related U.S. Application Data
(63) Continuation of application No. PCT/US2023/011598, filed on Jan. 26, 2023.
(60) Provisional application No. 63/303,145, filed on Jan. 26, 2022.

(51) Int. Cl. B01D 61/48

(52) U.S. Cl. CPC B01D 61/485; B01D 2313/08; B01D 2313/105; B01D 2313/125; B01D 2313/143

(57) ABSTRACT

An electrodeionization device includes a spacer comprising a first inlet port, a first outlet port, a first plurality of first flow channels configured to direct fluid in a first direction from the first inlet port to the first outlet port, and a second flow channel in series fluid communication with the first plurality of first flow channels between the first inlet port and first outlet port and configured to direct fluid in a second direction different from the first direction from the first inlet port to the first outlet port.

### BACKGROUND

### 1. Field of Disclosure

Aspects and embodiments disclosed herein are directed generally to electrochemical membrane systems and method of fabricating same.

### 2. Discussion of Related Art

Devices for purifying fluids using electrical fields may be used to treat water and other liquids containing dissolved ionic species. Two types of devices that treat water in this way are electrodeionization and electrodialysis devices. Within these devices are concentrating and diluting compartments separated by ion-selective membranes. An electrodialysis device typically includes alternating electroactive semipermeable anion and cation exchange membranes. Spaces between the membranes are configured to create liquid flow compartments with inlets and outlets. An applied electric field imposed via electrodes causes dissolved ions, attracted to their respective counter-electrodes, to migrate through the anion and cation exchange membranes. This generally results in the liquid of the diluting compartment being depleted of ions, and the liquid in the concentrating compartment being enriched with the transferred ions.

### SUMMARY

In accordance with one aspect, there is provided am electrochemical device including a spacer. The spacer comprises a first inlet port, a first outlet port, a first plurality of flow channels configured to direct fluid in a first planar direction parallel to a primary plane of the spacer in a portion of a flow path from the first inlet port to the first outlet port, and a manifold in series fluid communication with the first plurality of flow channels between the first inlet port and first outlet port and configured to direct fluid in a second planar direction parallel to the primary plane of the spacer different from the first planar direction in another portion of the flow path from the first inlet port to the first outlet port.

In some embodiments, the spacer further comprises an inlet manifold in series fluid communication between the first inlet port and the first plurality of flow channels and configured to direct fluid in a third planar direction parallel to the primary plane of the spacer and different from the first and second planar directions, and an outlet manifold in series fluid communication between the first outlet port and the first plurality of flow channels and configured to direct fluid in the third planar direction.

In some embodiments, the manifold is disposed along a diameter of the spacer.

In some embodiments, the first plurality of flow channels is disposed between the manifold and the first inlet.

In some embodiments, the spacer further comprises a second inlet.

In some embodiments, the second inlet is on a substantially opposite side of the spacer from the first inlet.

In some embodiments, the second plurality of flow channels is disposed between the manifold and the second inlet.

In some embodiments, a direction of fluid flow through the first plurality of flow channels is substantially opposite to a direction of fluid flow through the second plurality of flow channels.

In some embodiments, a direction of fluid flow through the manifold is substantially perpendicular to the direction of fluid flow through the first plurality of flow channels and the direction of fluid flow through the second plurality of flow channels.

In some embodiments, the manifold includes a wall disposed at an acute angle relative to an average direction of fluid flow through the manifold.

In some embodiments, the manifold includes two walls each disposed at acute angles relative to the average direction of fluid flow through the manifold.

In some embodiments, the manifold increases in cross-sectional area from an end furthest from the first outlet port to an end closest to the first outlet port.

In some embodiments, the manifold increases in width from an end furthest from the first outlet port to an end closest to the first outlet port.

In some embodiments, the first plurality of flow channels is disposed between the manifold and the first outlet.

In some embodiments, the spacer further comprises comprising a second outlet.

In some embodiments, the second outlet is on a substantially opposite side of the spacer from the first outlet.

In some embodiments, the second plurality of flow channels is disposed between the manifold and the second outlet.

In some embodiments, a direction of fluid flow through the first plurality of flow channels is substantially opposite to a direction of fluid flow through the second plurality of flow channels.

In some embodiments, a direction of fluid flow through the manifold is substantially perpendicular to the direction of fluid flow through the first plurality of flow channels and the direction of fluid flow through the second plurality of flow channels.

In some embodiments, the manifold increases in cross-sectional area from an end furthest from the first outlet port to an end closest to the first outlet port.

In some embodiments, the manifold increases in width from an end furthest from the first outlet port to an end closest to the first outlet port.

In some embodiments, the electrochemical device comprises an electrodeionization device and the first plurality of first flow channels included beads of anion and cation ion exchange resin each having a bimodal size distribution.

In some embodiments, beads of anion and cation ion exchange resin proximate walls of the first plurality of first flow channels have a smaller average size than beads of anion and cation ion exchange resin proximate centers of the first plurality of first flow channels and distal from the walls of the first plurality of first flow channels.

In some embodiments, the manifold includes apertures with a smaller size than sizes of the beads of ion exchange resin

In accordance with another aspect, there is provided am electrochemical device including a spacer. The spacer comprises a first inlet port, a first outlet port, and a first plurality of flow channels configured to direct fluid in a first direction in a portion of a fluid path from the first inlet port to the first outlet port, the plurality of flow channels configured to cause a velocity of fluid flow through the first plurality of flow channels to change with distance from the first inlet port.

In some embodiments, the spacer further comprises a manifold in series fluid communication with the first plurality of flow channels between the first inlet port and first outlet port and configured to direct fluid in a second direction different from the first direction in another portion of the flow path from the first inlet port to the first outlet port.

In some embodiments, the spacer further comprises a second inlet.

In some embodiments, the spacer further comprises a second plurality of flow channels disposed between the manifold and the second inlet.

In some embodiments, cross-sectional areas of the first plurality of flow channels change with distance from the first inlet port.

In some embodiments, the first plurality of flow channels change in height with distance from the first inlet port.

In some embodiments, the first plurality of flow channels change in width with distance from the first input port.

In some embodiments, the first plurality of first flow channels change in width with distance from the first input port.

In some embodiments, walls of the first plurality of flow channels are non-parallel.

In some embodiments, cross-sectional areas of the first plurality of flow channels remain substantially the same with distance from the first inlet port, and at least one of widths or heights of the first plurality of flow channels change with distance from the first inlet port.

In some embodiments, the spacer is a dilute spacer and the first plurality of first flow channels are diluting compartments.

In some embodiments, the electrochemical device further comprises a concentrate spacer having an upper surface disposed against a lower surface of the dilute spacer, the concentrate spacer including a third plurality of flow channels having dimensions complimentary to dimensions of the first plurality of flow channels.

In some embodiments, the electrochemical device comprises an electrodeionization device and one or more of the first plurality of flow channels, the second plurality of flow channels, or the third plurality of flow channels include beads of anion and cation ion exchange resin each having a bimodal size distribution, the dilute spacer and the concentrate spacer forming a cell pair exhibiting an electrical conductivity at least 20% higher than the conductivity of a cell pair including the dilute spacer and concentrate spacer each including only anion exchange resin beads with uniform sizes and cation exchange resin beads with uniform sizes.

In some embodiments, the second plurality of flow channels change in height with distance from the second inlet port at a same rate as the first plurality of flow channels change in height with distance from the first inlet port.

In some embodiments, the electrochemical device comprises an electrodeionization device and the first plurality of flow channels includes beads of anion and cation ion exchange resin each having a bimodal size distribution.

In accordance with another aspect, there is provided am electrochemical device including a spacer. The spacer comprises an inlet port, an outlet port, a first plurality of flow channels configured to direct fluid from the inlet port to the outlet port, a second plurality of flow channels configured to direct fluid from the inlet port to the outlet port, and a mixing zone disposed fluidically between the first plurality of flow channels and the second plurality of flow channels, the mixing zone configured to receive fluid from each of the first plurality of flow channels and direct the fluid into each of the second plurality of flow channels.

In some embodiments, the mixing zone includes a wall disposed between the first plurality of flow channels and second plurality of flow channels, the wall having a plurality of apertures configured to facilitate mixing of fluid in the mixing chamber.

In some embodiments, the wall defines downstream ends of the first plurality of flow chambers.

In some embodiments, the first plurality of flow channels includes beads of ion exchange resin and the plurality of apertures have dimensions smaller than the beads of ion exchange resin.

In some embodiments, the mixing chamber includes internal structures configured to promote mixing of fluid introduced into the mixing chamber from the first plurality of flow channels.

In some embodiments, the mixing chamber further includes a second wall disposed between the first plurality of flow channels and second plurality of flow channels, the second wall having a second plurality of apertures.

In some embodiments, the second wall defines upstream ends of the second plurality of fluid channels.

In some embodiments, the second plurality of flow channels includes beads of ion exchange resin and the second plurality of apertures have dimensions smaller than the beads of ion exchange resin.

In some embodiments, the first plurality of flow channels and the second plurality of flow channels are equal in number.

In some embodiments, each of the first plurality of flow channels is aligned with a corresponding one of the second plurality of flow channels.

In some embodiments, the first plurality of flow channels and the second plurality of flow channels have substantially same dimensions.

In some embodiments, a direction of fluid flow through the first plurality of flow channels is substantially parallel to a direction of fluid flow through the second plurality of flow channels.

In some embodiments, a velocity of fluid flow through the first plurality of flow channels is substantially the same as a velocity of fluid flow through the second plurality of flow channels.

In some embodiments, the mixing zone has a width in an average direction of fluid flow through the mixing zone that is less than widths of the first plurality of flow channels in a direction perpendicular to an average direction of fluid flow through the first plurality of flow channels.

In some embodiments, the width of the mixing zone is substantially constant across a length of the mixing zone.

In some embodiments, the mixing zone has a length in a direction perpendicular to an average direction of fluid flow through the mixing zone that is greater than lengths of the first plurality of flow channels in an average direction of fluid flow through the first plurality of flow channels.

In some embodiments, the length of the mixing zone is substantially constant across a width of the mixing zone.

In some embodiments, the electrochemical device comprises an electrodeionization device and the first plurality of flow channels includes beads of anion and cation ion exchange resin having a different average size than beads of anion and cation ion exchange resin included in the second plurality of flow channels.

In some embodiments, the first plurality of flow channels includes beads of anion and cation ion exchange resin each having a unimodal size distribution.

In some embodiments, the second plurality of flow channels includes beads of anion and cation ion exchange resin each having a bimodal size distribution.

In accordance with another aspect, there is provided electrodeionization device including a spacer. The spacer comprises an inlet port, an outlet port, a first plurality of flow channels configured to direct fluid from the inlet port to the outlet port, a second plurality of flow channels configured to direct fluid from the inlet port to the outlet port. The second plurality of flow channels are one of in series with the first plurality of flow channels, or configured to flow fluid in an opposite direction from a direction of fluid flow through the first plurality of flow channels. Ion exchange media beads are disposed within each of the first plurality of flow channels and the second plurality of flow channels. A size distribution of the ion exchange media beads changes from an inlet to an outlet of the first plurality of flow channels, from an inlet to an outlet of the second plurality of flow channels, or from the first plurality of flow channels to the second plurality of flow channels.

In some embodiments, the ion exchange media beads include cation exchange media beads and anion exchange media beads.

In some embodiments, the cation exchange media beads have a different size distribution than the anion exchange media beads.

In some embodiments, the first plurality of flow channels or the second plurality of flow channels includes different number ratios of the cation exchange media beads to the anion exchange media beads.

In some embodiments, one of the first plurality of flow channels or the second plurality of flow channels includes a substantially same total surface area of the cation exchange media beads and the anion exchange media beads.

In some embodiments, one of the first plurality of flow channels or the second plurality of flow channels includes cation exchange media beads having a first packing density and anion exchange media beads having a second packing density different from the first packing density.

In some embodiments, one of the first plurality of flow channels or the second plurality of flow channels includes cation exchange media beads having a first unimodal size distribution with a first median size and anion exchange media beads having a second unimodal size distribution with a second median size different from the first median size.

In some embodiments, one of the cation exchange media beads or the anion exchange media beads have a bimodal size distribution.

In some embodiments, the cation exchange media beads and the anion exchange media beads collectively increase in volume during use of the electrodeionization device as compared to when initially packed into the first and second plurality of flow channels and decrease a void volume within the first and second plurality of flow channels by at least 5%.

In some embodiments, the cation exchange media beads include larger beads having substantially same sizes and smaller beads having substantially same sizes.

In some embodiments, the first and second pluralities of flow channels are arranged in series and an average size of the ion exchange media beads decreases with distance along a flow path through the first and second pluralities of flow channels.

In some embodiments, the second plurality of flow channels are disposed downstream of the first plurality of flow channels and an average size of the ion exchange media beads is smaller in the second plurality of flow channels than in the first plurality of flow channels.

In some embodiments, an average size of the ion exchange media beads decreases with distance along a flow path through one of the first plurality of flow channels or the second plurality of flow channels.

In some embodiments, a packing density of the ion exchange media beads changes from an inlet to an outlet of the first plurality of flow channels, from an inlet to an outlet of the second plurality of flow channels, or from the first plurality of flow channels to the second plurality of flow channels.

In some embodiments, a packing density of the ion exchange media beads is higher proximate walls than proximate central regions of one of the first plurality of flow channels or the second plurality of flow channels.

In some embodiments, one of the first plurality of flow channels or the second plurality of flow channels includes a layered bed of ion exchange resin including a layer of cation ion exchange resin, a layer of anion exchange resin, and a layer of mixed anion and cation ion exchange resin.

In some embodiments, the electrochemical device or electrodeionization device further comprises a profiled ion exchange membrane disposed on one or both of upper or lower sides of the spacer.

Still other aspects, embodiments, and advantages of these exemplary aspects and embodiments, are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A shows an example of an assembled electrodeionization (EDI) device;

FIG. 1B shows a partially exploded view of an example of an EDI device;

FIG. 1C illustrates an example of a cell pair of an EDI device;

FIG. 1D illustrates fluid flow streams though the example of cell pair of an EDI device of FIG. 1C;

FIG. 2 illustrates examples of EDI device dilute and a concentrate spacers;

FIG. 3 illustrates an example of a high flow EDI spacer set;

FIG. 4A illustrates one example of fluid flow through an EDI spacer;

FIG. 4B illustrates another example of fluid flow through an EDI spacer;

FIG. 5 illustrates another example of a high flow EDI spacer;

FIG. 6 illustrates an example of a high flow EDI dilute spacer;

FIG. 7 illustrates an example of a high flow EDI concentrates spacer that may mate with the dilute spacer of FIG. 6;

FIG. 8 illustrates an example an EDI spacer including flow channels with changing widths;

FIG. 9 illustrates an example an EDI spacer including a mixing zone;

FIG. 10 illustrates how the packing density of anion and cation ion exchange beads may vary in a flow channel of an EDI spacer;

FIG. 11 illustrates how anion and cation ion exchange beads in a flow channel of an EDI spacer may have different size distributions;

FIG. 12 illustrates how anion or cation ion exchange beads in a flow channel of an EDI spacer may have different populations with different size distributions;

FIG. 13A illustrates how the size of ion exchange media beads may change along a flow path through flow channels of an EDI spacer;

FIG. 13B illustrates another way how the size of ion exchange media beads may change along a flow path through flow channels of an EDI spacer;

FIG. 14A illustrates how the packing density of ion exchange media beads may change along a flow path through flow channels of an EDI spacer;

FIG. 14B illustrates another way how the packing density of ion exchange media beads may change along a flow path through flow channels of an EDI spacer;

FIG. 15 illustrates how the size and packing density of ion exchange media in a flow channel of an EDI spacer may change with distance from walls of the flow channel;

FIG. 16 illustrates how different types of ion exchange media bead beds may be layered in a flow channel of an EDI spacer

FIG. 17A illustrates a portion of an example of a profiled ion exchange membrane including protrusions in the form of partial spheres that may be utilized in embodiments disclosed herein;

FIG. 17B illustrates beads of ion exchange resin disposed on the surface of the profiled ion exchange membrane of FIG. 17A;

FIG. 17C illustrates dimensions of the protrusions of the profiled ion exchange membrane of FIG. 17A;

FIG. 17D illustrates spacing of the protrusions of the profiled ion exchange membrane of FIG. 17A;

FIG. 17E illustrates a portion of an example of a profiled ion exchange membrane including protrusions in the form of posts that may be utilized in embodiments disclosed herein;

FIG. 17F is an isometric view illustrating beads of ion exchange resin disposed on the surface of the profiled ion exchange membrane of FIG. 17E;

FIG. 17G is a cross-sectional view illustrating beads of ion exchange resin disposed on the surface of the profiled ion exchange membrane of FIG. 17E;

FIG. 17H is an isometric view illustrating two layers of beads of ion exchange resin disposed on the surface of the profiled ion exchange membrane of FIG. 17E;

FIG. 17I illustrates dimensions of the protrusions of the profiled ion exchange membrane of FIG. 17E;

FIG. 17J illustrates spacing of the protrusions of the profiled ion exchange membrane of FIG. 17E;

FIG. 17K illustrates a portion of an example of a profiled ion exchange membrane including recesses that may be utilized in embodiments disclosed herein;

FIG. 17L is an isometric view illustrating beads of ion exchange resin disposed on the surface of the profiled ion exchange membrane of FIG. 17K;

FIG. 17M is a cross-sectional view illustrating beads of ion exchange resin disposed on the surface of the profiled ion exchange membrane of FIG. 17K;

FIG. 17N illustrates dimensions of the recesses of the profiled ion exchange membrane of FIG. 17K; and

FIG. 17O illustrates spacing of the recesses of the profiled ion exchange membrane of FIG. 17K.

### DETAILED DESCRIPTION

Aspects and embodiments disclosed herein are not limited to the details of construction and the arrangement of components set forth in the following description or illustrated in the drawings. Aspects and embodiments disclosed herein are capable of other embodiments and of being practiced or of being carried out in various ways.

Electrodeionization (EDI) is a process that removes, or at least reduces, one or more ionized or ionizable species from water using electrically active media and an electric potential to influence ion transport. The electrically active media typically serves to alternately collect and discharge ionic and/or ionizable species and, in some instances, to facilitate the transport of ions, which may be continuously, by ionic or electronic substitution mechanisms. EDI devices can comprise electrochemically active media of permanent or temporary charge, and may be operated batch-wise, intermittently, continuously, and/or even in reversing polarity modes. EDI devices may be operated to promote one or more electrochemical reactions specifically designed to achieve or enhance performance. Further, such electrochemical devices may comprise electrically active membranes, such as semipermeable or selectively permeable ion exchange or bipolar membranes. Continuous electrodeionization (CEDI) devices are EDI devices known to those skilled in the art that operate in a manner in which water purification can proceed continuously, while ion exchange material is continuously recharged. CEDI techniques can include processes such as continuous deionization, filled cell electrodialysis, or electrodiaresis. Under controlled voltage and salinity conditions, in CEDI systems, water molecules can be split to generate hydrogen or hydronium ions or species and hydroxide or hydroxyl ions or species that can regenerate ion exchange media in the device and thus facilitate the release of the trapped species therefrom. In this manner, a water stream to be treated can be continuously purified without requiring chemical recharging of ion exchange resin.

Electrodialysis (ED) devices operate on a similar principle as CEDI, except that ED devices typically do not contain electroactive media between the membranes. Because of the lack of electroactive media, the operation of ED may be hindered on feed waters of low salinity because of elevated electrical resistance. Also, because the operation of ED on high salinity feed waters can result in elevated electrical current consumption, ED apparatus have heretofore been most effectively used on source waters of intermediate salinity. In ED based systems, because there is no electroactive media, splitting water is inefficient and operating in such a regime is generally avoided.

In CEDI and ED devices, a plurality of adjacent cells or compartments are typically separated by selectively permeable membranes that allow the passage of either positively or negatively charged species, but typically not both. Dilution or depletion compartments are typically interspaced with concentrating or concentration compartments in such devices. In some embodiments, a cell pair may refer to a pair of adjacent concentrating and diluting compartments. As water flows through the depletion compartments, ionic and other charged species are typically drawn from the depletion compartments into adjacent concentrating compartments under the influence of an electric field, such as a DC field. Positively charged species are drawn toward a cathode, typically located at one end of a stack of multiple depletion and concentration compartments, and negatively charged species are likewise drawn toward an anode of such devices, typically located at the opposite end of the stack of compartments. The electrodes are typically housed in electrolyte compartments that are usually partially isolated from fluid communication with the depletion and/or concentration compartments. Once in a concentration compartment, charged species are typically trapped by a barrier of selectively permeable membrane at least partially defining the concentration compartment. For example, anions are typically prevented from migrating further toward the cathode, out of the concentration compartment, by a cation selective membrane. Once captured in the concentrating compartment, trapped charged species can be removed in a concentrate stream.

In CEDI and ED devices, the DC field is typically applied to the cells from a source of voltage and electric current applied to the electrodes (anode or positive electrode, and cathode or negative electrode). The voltage and current source (collectively “power supply”) can be itself powered by a variety of means such as an AC power source, or, for example, a power source derived from solar, wind, or wave power. At the electrode/liquid interfaces, electrochemical half-cell reactions occur that initiate and/or facilitate the transfer of ions through the membranes and compartments. The specific electrochemical reactions that occur at the electrode/interfaces can be controlled to some extent by the concentration of salts in the specialized compartments that house the electrode assemblies. For example, a feed to the anode electrolyte compartments that is high in sodium chloride will tend to generate chlorine gas and hydrogen ions, while such a feed to the cathode electrolyte compartment will tend to generate hydrogen gas and hydroxide ions. Generally, the hydrogen ions generated at the anode compartment will associate with free anions, such as chloride ions, to preserve charge neutrality and create hydrochloric acid solution, and analogously, the hydroxide ions generated at the cathode compartment will associate with free cations, such as sodium ions, to preserve charge neutrality and create sodium hydroxide solution. The reaction products of the electrode compartments, such as generated chlorine gas and sodium hydroxide, can be utilized in the process as needed for disinfection purposes, for membrane cleaning and defouling purposes, and for pH adjustment purposes.

Plate-and-frame and spiral wound designs have been used for various types of electrochemical deionization devices including but not limited to electrodialysis (ED) and electrodeionization (EDI) devices. Commercially available ED devices are typically of plate-and-frame design, while EDI devices are available in both plate and frame and spiral configurations.

An electrodeionization (EDI) device is typically assembled from a stack of cell pairs bounded on both ends by electrodes, endblocks and endplates. Each cell pair consists of a cation exchange membrane, a spacer that defines the diluting compartment(s), an anion exchange membrane and a spacer that defines the concentrating compartment(s). The entire assembly of stacked components is mechanically compressed and secured by tie-rods.

The diluting and concentrating compartments are filled with ion exchange media to enhance transport of ions and reduce the electrical resistance. In most commercially available EDI devices, the media comprises ion exchange resins. The inter-membrane distance in the compartments can be in the range of 0.09 to 0.40 inch (0.23-1.0 cm).

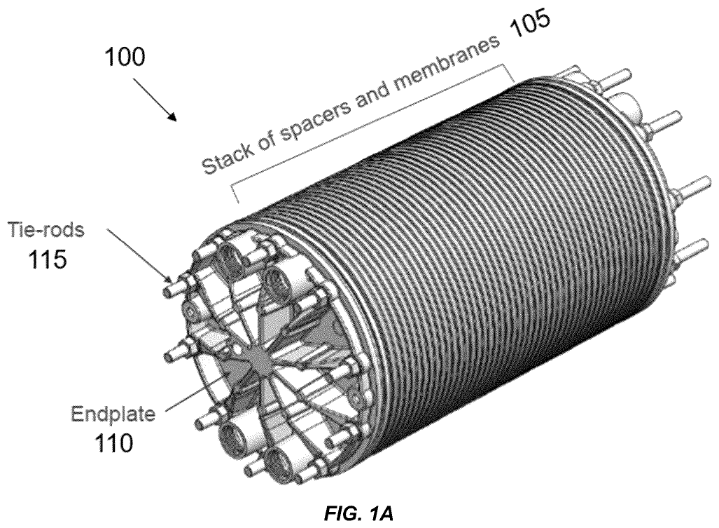

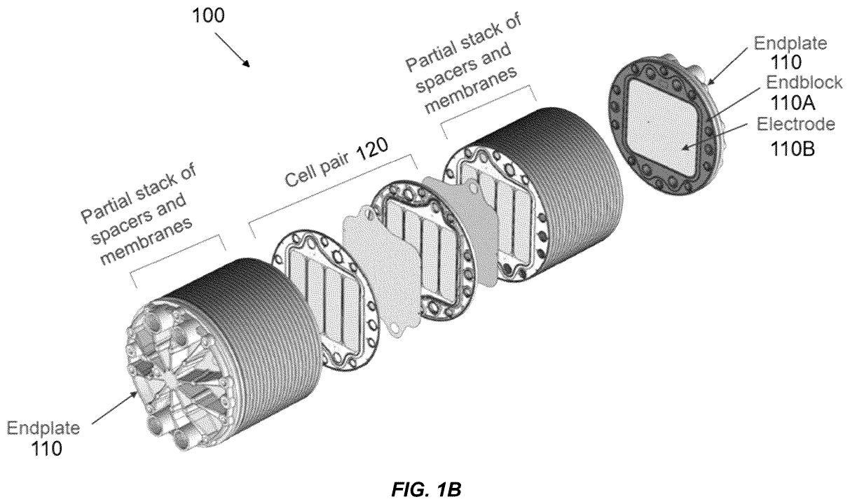

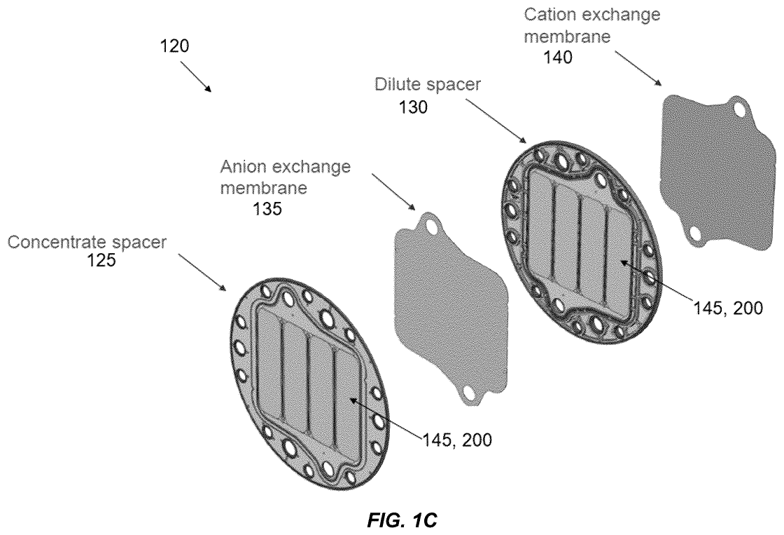

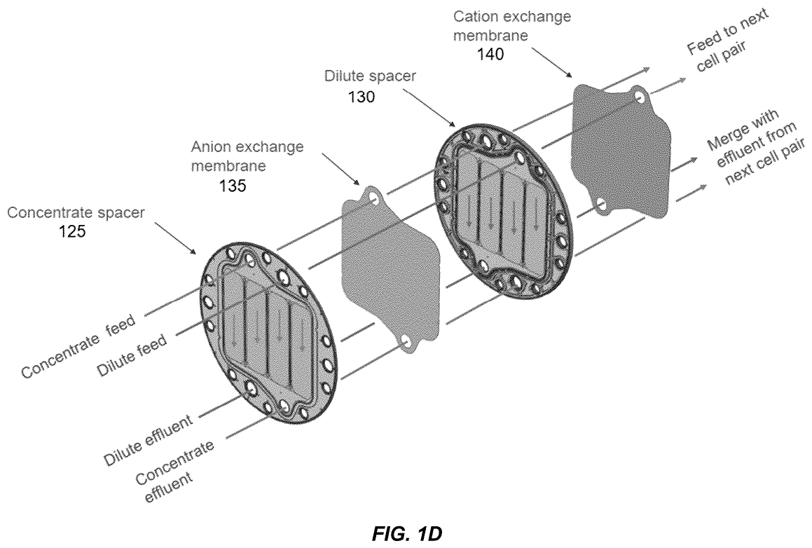

One example of an EDI device is illustrated in perspective view in FIGS. 1A and 1n a partially exploded view in FIG. 1B. As illustrated, the EDI device 100 includes a plurality of stacked spacers and ion selective permeable membranes, collectively indicated at 105 in FIG. 1A, held together between a pair of endplates 110. The endplates 110 are in turn coupled to one another by a plurality of tie rods 115 which apply pressure to the stack of spacers and membranes to help prevent leaks through the sides of the spacers. As illustrated in FIG. 1B, the endplates 110 each include endblocks 110 and electrodes 110B—an anode in one of the endplates 110 and a cathode in the other endplate 110. The stack of spacers and membranes includes a plurality of cell pairs 120. As illustrated in further detail in FIG. 1C, the cell pairs 120 include a concentrate spacer 125, a dilute or diluting spacer 130, and ion exchange membranes disposed between each concentrate spacer 125 and dilute spacer 130. The ion exchange membranes include an anion exchange membrane 135 which selectively passes anions and a cation exchange membrane 140 which selectively passes cations. Each concentrate spacer 125 has an anion exchange membrane 135 on one side and a cation exchange membrane 140 on the other side. Similarly, each dilute spacer 130 has an anion exchange membrane 135 on one side and a cation exchange membrane 140 on the other side. A plurality of cell pairs 120 such as illustrated in FIG. 1C are sequentially stacked to form the stack of spacers and membranes 105.

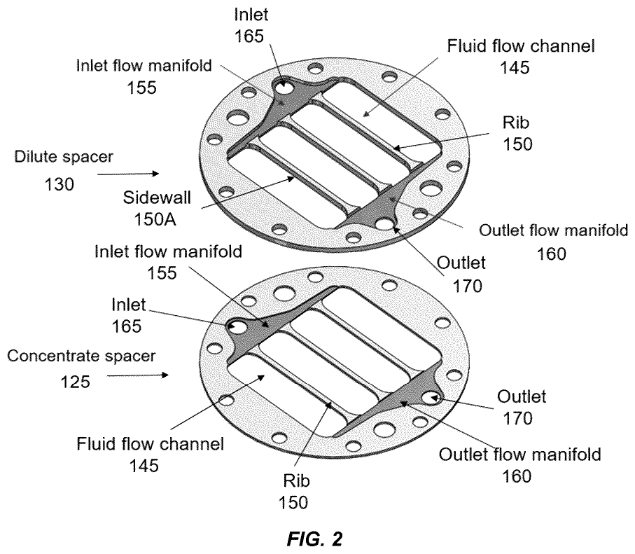

Each of the dilute spacers 130 includes flow channels 145 through which an aqueous solution to be purified flows. Each of the concentrate spacers 125 includes flow channels 145 through which an aqueous solution flows to receive ions removed from the aqueous solution flowing through the flow channels 145 of the dilute spacers that pass through the anion exchange membrane 135 and cation exchange membrane 140 between each concentrate spacer 125 and adjacent dilute spacers 130. The flow channels 145 are filled with ion exchange media 200, typically in the form of anion and/or cation exchange resin beads, which promote transfer of ions through the flow channels 145. The flow channels 145 are separated by ribs 150 having sidewalls 150A (See FIG. 2) that define the lateral extents of the flow channels 145. The ribs 150 and their sidewalls 150A may be considered to define the sides of the flow channels 145 and the anion exchange membranes 135 and cation exchange membranes 140 may be considered to define the tops and bottoms of the flow channels 145. The same applies to the additional flow channels 145A-145D described below. In some embodiments an anion exchange membrane 135 may define a top wall of a flow channel of a dilute spacer or a concentrate spacer and a cation exchange membrane 140 may define the bottom wall of a flow channel of a dilute spacer or a concentrate spacer. Alternatively, an anion exchange membrane 135 may define a bottom wall of a flow channel of a dilute spacer or a concentrate spacer and a cation exchange membrane 140 may define the top wall of a flow channel of a dilute spacer or a concentrate spacer.

Typical flow paths of feed and effluent through the cell pair are illustrated in FIG. 1D. The fluid flow direction through the flow channels 145 in the concentrate spacer 125 and dilute spacer 130 are shown as parallel in FIG. 2, but in other embodiments, these fluid low directions may be counter-current.

A pair of spacers including a concentrate spacer 125 and a dilute spacer 130 are further illustrated in FIG. 2 with the intervening ion exchange membrane omitted to illustrate the inlet and outlet manifolds 155, 160 that fluidically couple the inlets and outlets 165, 170 (also referred to herein as inlet ports and outlet ports) to the fluid flow channels 145. It should be appreciated that the positions of the inlets and outlets and associated manifolds may be reversed from what is illustrated for either or both of the spacer types.

An EDI device is typically designed for a nominal flow rate, deionization performance and pressure drop. Increasing the flow rate above the nominal flow rate can reduce the capital cost per unit flow rate. In a system with multiple devices in parallel to meet a specified flow rate, increasing the flow rate per device would reduce the number of devices necessary and thereby the capital cost for the EDI devices as well as supporting equipment such as power supplies, piping, and instrumentation and controls.

Increasing the flow rate, however, may reduce deionization performance and increase pressure drop to the extent that the EDI system no longer meets specifications and performance guarantees.

One method of increasing the flow rate per EDI device is to increase the size of the spacers so that the total volume of the flow compartments is increased. A VNX™ EDI device dilute spacer from Evoqua Water Technologies, LLC, for example, has an overall diameter of 17 inch (43.2 cm). Increasing the diameter D to 24 in (61.0 cm) and assuming that the volume in the diluting compartment (the volume defined by the flow channels) increases correspondingly by D², the flowrate per spacer would double to 1.1 gpm (4.15 lpm) if the residence time is maintained the same. The pressure drop per spacer would increase, however, due to an increase in the path length down the channels and higher flow velocity. The force on the closing mechanism (endblocks, endplates, and tie-rods) due to internal pressure would double and the structural design and cost may become challenging.

Aspects and embodiments disclosed herein include methods and spacer structure modifications for increasing the flow rate in an EDI device without adversely affecting performance and pressure drop.

In one embodiment, an EDI spacer comprises at least two sets of flow channels; each set includes multiple channels with feed from a common inlet manifold and discharge into a common outlet manifold. The two sets of channels can be fluidically connected in parallel or in series. The size distribution of the ion exchange resins in the channels are selected so that the EDI device meets specified deionization performance and pressure drop. In some embodiments, the resins have diameters of less than 400 μm. In some embodiments, EDI dilute and/or concentrate spacer flow channels may include beads of anion and cation ion exchange resin each having a bimodal size distribution and the dilute spacer and the concentrate spacer may form a cell pair exhibiting an electrical conductivity at least 20% higher than the conductivity of a cell pair including the dilute spacer and concentrate spacer each including only anion exchange resin beads with uniform sizes and cation exchange resin beads with uniform sizes. This may apply to any of the spacer structures disclosed herein.

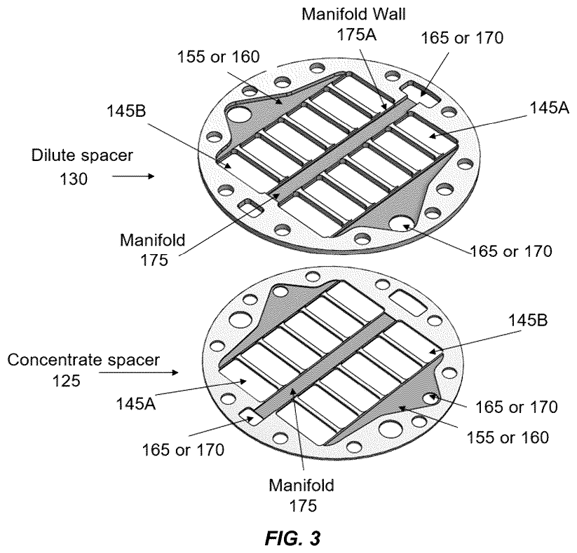

FIG. 3 shows one embodiment of a high flow EDI spacer set. In each of the concentrate and dilute spacers 125, 130 the flow channels 145, as illustrated in the spacers of FIG. 2, are split into a plurality of first flow channels 145A and a plurality of second flow channels 145B. A central manifold 175, also referred to herein as a second manifold 175 or as simply manifold 175 to distinguish from the inlet and outlet flow manifolds 155, 160 (labelled in FIG. 2), is disposed between and in series fluid communication with the plurality of first flow channels 145A and plurality of second flow channels 145B. The manifold 175 may include fluid permeable walls 175A, for example, walls including apertures to provide for fluid flow between the interior of the manifold 175 and the first and second pluralities of flow channels 145A, 145B. The apertures in the walls 175A may have dimensions smaller than average or smallest dimensions of ion exchange resin beads in the plurality of first flow channels 145A and/or plurality of second flow channels 145B to keep the resin beads from passing from the flow channels 145A, 145B into the manifold 175. Alternatively, there may be no walls 175A and the manifold 175 may be defined by an open space between the plurality of first flow channels 145A and plurality of second flow channels 145B. As shown in FIG. 2, the manifold 175 may be disposed centrally or along diameters of the concentrate and dilute spacers 125, 130.

The plurality of first flow channels 145A directs fluid in a first planar direction parallel to a primary plane of the spacers 125, 130 in a portion of a flow path from an inlet port 165 to an outlet port 170 of each respective spacer. The primary plane of the spacers is a plane parallel to the upper and/or lower surfaces of the spacers. The manifold 175 directs fluid in a second planar direction parallel to a primary plane of the spacers 125, 130 in another portion of the flow path from an inlet port to an outlet port of each respective spacer. The first and second planar directions may be different or the same. The plurality of second flow channels 145B directs fluid in a third planar direction parallel to a primary plane of the spacers 125, 130 in a portion of a flow path from an inlet port to an outlet port of each respective spacer. The third planar direction may be different or the same as either of the first planar direction or the second planar direction. The positions of the plurality of first flow channels 145A and plurality of second flow channels 145B may be opposite to what is illustrated in FIG. 3 for either or both of the spacers 125, 130.

A portion of the fluid flow through the manifold 175 may be parallel to the direction of fluid flow through the first and/or second flow channels 145A, 145B, for example, where fluid enters or exits the manifold 175 from or into the first and/or second flow channels 145A, 145B. Fluid is also directed a planar direction parallel to a primary plane of the spacers 125, 130 in the inlet and outlet flow manifolds 155, 160. At least a portion of the fluid flow through the inlet and outlet flow manifolds 155, 160 may be parallel to a lengthwise extension of the first and/or second flow channels 145A, 145B and another portion of the fluid flow through the inlet and outlet flow manifolds 155, 160 may be parallel to a lengthwise extension of the manifold 175.

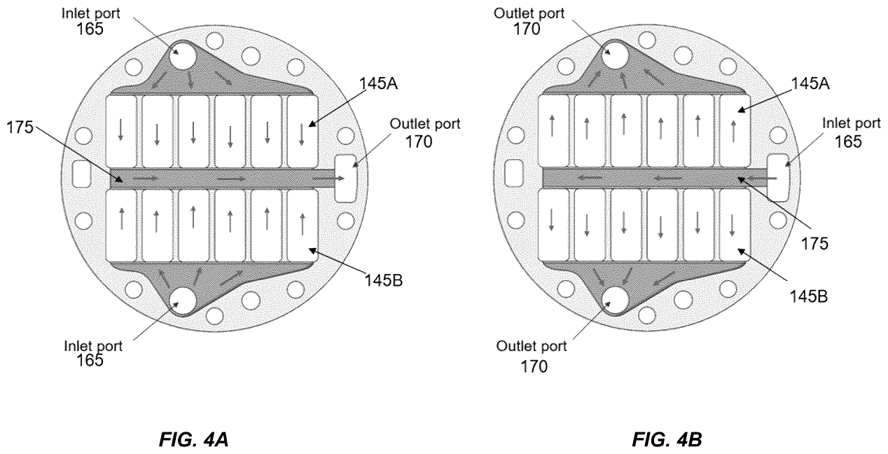

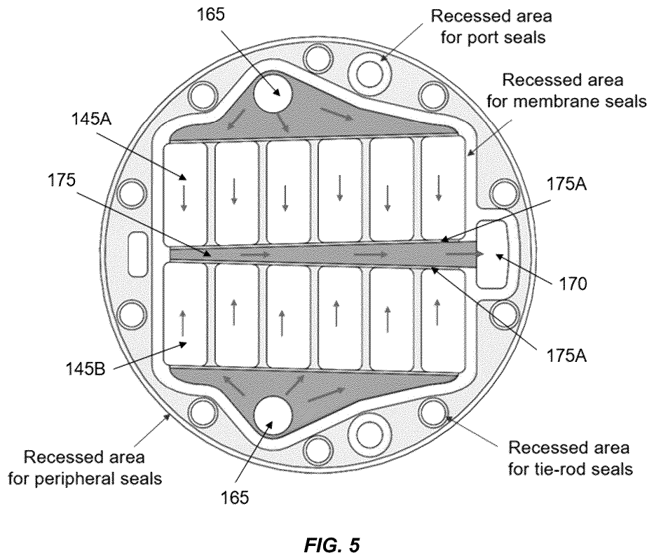

The concentrated and/or dilute spacers 125, 130 may include either one or two inlet ports 165 and one or two outlet ports 170. As indicated in FIG. 3 any individual port may be either an inlet port 165 or an outlet port 170. Other embodiments may include even greater numbers of inlet and outlet ports. Depending on the port configuration and which ports are inlet or outlet ports, an average direction of fluid flow through the first and second flow channels 145A, 145B may be each toward the manifold 175 or away from the manifold 175 as illustrated in the two different spacer port configurations show in FIGS. 4A and 4B.

Arrows indicating two different options for the direction of fluid flow through the channels of the dilute spacer 130 are shown in FIGS. 4A and 4B. It is to be understood that similar options for the direction of fluid flow through the channels of the concentrate spacer 125 are also encompassed by the present disclosure. The spacers of FIGS. 4A and 4B and in the other figures are illustrated in a simplified manner, without features such as caps and seals.

In spacers with the port and fluid flow configuration as illustrated in FIG. 4A, the first plurality of flow channels 145A is disposed between the manifold 175 and a first inlet port 165. The spacer of FIG. 4A includes a second inlet port 165 on a substantially opposite side of the spacer and on an opposite side of the manifold 175 from the first inlet port 165. The second plurality of flow channels 145B is disposed between the manifold 175 and the second inlet port 165. In each spacer, feed from two inlet ports enters and flows through the two sets of flow channels 145A, 145B in parallel, but opposite, directions. The effluent from the flow channels 145A, 145B is collected in the manifold 175 and discharged through a single outlet port 170. A direction of fluid flow, or an average direction of fluid flow, through the first plurality of flow channels 145A is substantially opposite to a direction of fluid flow through the second plurality of flow channels 145B because the average direction of fluid flow through each of the flow channels 145A, 145B is from the respective inlet ports 165 toward the centrally located manifold 175. The fluid flow through the flow channels 145A, 145B may be considered convergent. The average direction of fluid flow through the manifold 175 is substantially perpendicular to the average direction of fluid flow through the first plurality of flow channels 145A and the average direction of fluid flow through the second plurality of flow channels 145B. It is to be understood that fluid flow through the flow channels 145A, 145B, the manifold 175, and other structures described herein with respect to other embodiments may include vortices or eddies and not be completely laminar, so the term “direction of fluid flow” as used herein should be interpreted as “average direction of fluid flow” unless otherwise indicated.

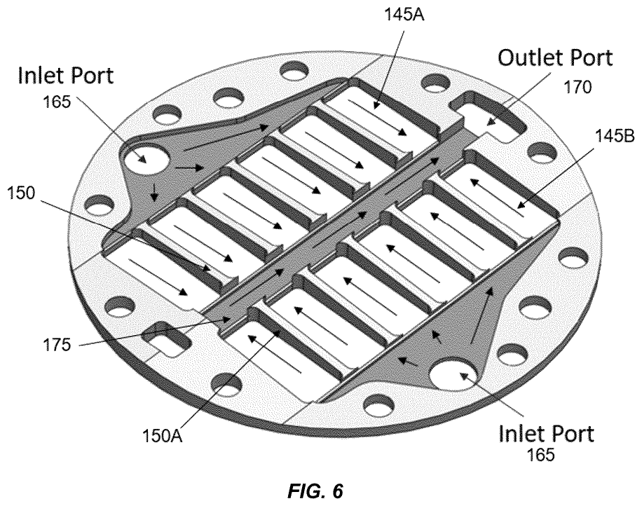

In some embodiments, the manifold 175 may increase in cross-sectional area, for example, in width from an end distal to or furthest from the outlet port 170 to an end proximate or closest to the outlet port 170 as illustrated in FIG. 5. This may allow the manifold 175 to accommodate additional fluid flow as fluid is provided into the manifold 175 from additional of the first and second pluralities of flow channels 145A, 145B. Accordingly, the manifold 175 may include a wall 175A disposed at an acute angle relative to an average direction of fluid flow through the manifold 175 or the manifold 175 may include two walls 175A each disposed at acute angles relative to the average direction of fluid flow through the manifold. In other embodiments, the manifold 175 may increase in height from an end distal to or furthest from the outlet port 170 to an end proximate or closest to the outlet port 170 in addition to or as an alternative to increasing in width from an end distal to or furthest from the outlet port 170 to an end proximate or closest to the outlet port 170.

With renewed reference to FIGS. 4A and 4B, the role of the inlet and outlet ports, 165, 170 can be reversed, as shown in FIG. 4B as compared to FIG. 4A. In FIG. 4B, the spacer includes two outlet ports 170 and one inlet port 165. Fluid flows into the manifold 175 from the inlet port 165 and through the first and second pluralities of flow channels 145A, 145B to respective first and second outlet ports 170. In such a configuration the first plurality of flow channels 145A disposed between the manifold 175 and the first outlet 170 and the second plurality of flow channels is 145B disposed between the manifold 175 and the second outlet 170. Like the inlet ports in FIG. 4A, in FIG. 4B, the first and second outlets 170 are on substantially opposite sides of the spacer and on opposite sides of the manifold 175. The direction of fluid flow through the first plurality of flow channels 145A is substantially opposite to the direction of fluid flow through the second plurality of flow channels 145B because fluid flows through both the first and second pluralities of flow channels 145A, 145B away from the manifold 175 toward the respective outlets 170. The fluid flow through the first and second pluralities of flow channels 145A, 145B may be considered divergent. The direction of fluid flow through the manifold 170 is substantially perpendicular to the direction of fluid flow through the first plurality of flow channels 145A and the direction of fluid flow through the second plurality of flow channels 145B. In some embodiments, in the configuration of FIG. 4B, the manifold 175 may increase in cross-sectional area, for example, in width and/or height in a similar manner as illustrated in FIG. 5. The increase in cross-sectional area would occur along a path from an end proximate or closest to the inlet port 165 (from an end distal to or furthest from the outlet port 170) to an end distal to or furthest from the inlet port 165 (to an end proximate or closest to the outlet port 170).

Assuming that the overall size of the spacers is maintained the same as spacers of the current art, the flow path length per fluid flow channel would be decreased. For example, the dilute spacer in FIG. 3 (hereby referred to as the “high flow” spacer) may have fluid flow channel 145A, 145B lengths of 4.0 in (10.2 cm) vs. 9.1 in (23.1 cm) in the VNX™ EDI device dilute spacer—the fluid flow channels 145 illustrated in the spacer of FIG. 2. The total volume in the diluting compartments (combining both set of channels) is 27.53 in³ (451.1 cm³), which is 93% that of the VNX™ EDI device spacer. To increase the flow rate per spacer, the residence time in the high flow spacer may be less than that of the VNX™ EDI device dilute spacer. Reducing residence time is generally expected to reduce the deionization performance because there would be less time for ionic contaminants to pass vertically through the fluid flow channels 145A, 145B of the dilute spacers 130 and across the anion and/or cation selective membranes 135, 140 into the fluid flow channels 145A, 145B of adjacent concentrate spacers 125. Methods to counter this effect are discussed below.

The embodiment of FIG. 5, discussed above, may address the problem of reduced residence time due to reduced fluid flow channel length. The ends of each fluid flow channel 145A, 145B are not at right angles to the sides of the fluid flow channels 145A, 145B. The angled fluid flow channels 145A, 145B allow more space for the membrane seals and the tapered manifold 175 reduces the variation in flow velocity as the effluent from the fluid flow channels 145A, 145B are collected and directed to the outlet port 170. Further, as discussed in more detail below, in the embodiment of FIG. 5, as well as the other embodiments disclosed herein, the size or size distributions of anion and cation exchange media beads within the fluid flow channels 145A, 145B of the concentrate and/or dilute spacer 125, 130 may be adjusted, for example, reduced in average size to increase a rate of transport of ionic species through the fluid flow channels 145A, 145B of the dilute spacer 130 and into the fluid flow channels 145A, 145B of the concentrate spacer 125.

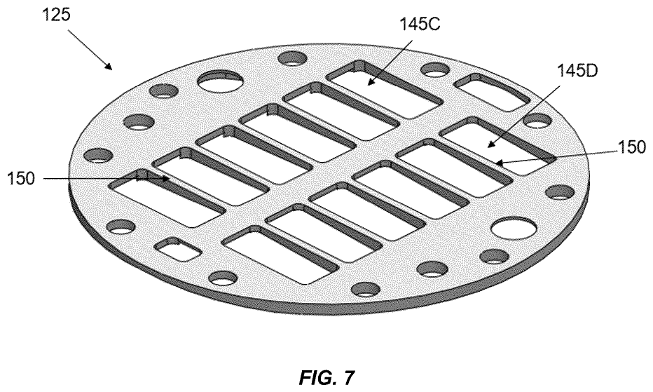

FIG. 6 shows another embodiment of a dilute spacer 130 which may address the problem of reduced residence time due to reduced fluid flow channel length. In the spacer of FIG. 6 the plurality of fluid flow channels 145A, 145B are configured to cause a velocity of fluid flow to change with distance from the first and second inlet ports 165. Some ionic species may flow out of the dilute spacer 130 and into an adjacent concentrate spacer 125 at the upstream ends of the fluid flow channels 145A, 145B thus lowering the ionic concentration of the fluid with flow distance through the fluid flow channels 145A, 145B. The velocity of fluid flow may slow with distance through the plurality of fluid flow channels 145A, 145B to allow more time for ionic species to flow out of the dilute spacer 130 and into an adjacent concentrate spacer 125 as the concentration of ionic species in the fluid being treated becomes less. The cross-sectional areas of the first plurality of flow channels 145A and the second plurality of flow channels 145B change with distance from the first and second inlet ports 165, respectively. The ribs 150 defining the fluid flow channels 145A, 145B increase in height along their respective fluid flow paths, such that the thickness or height of the fluid flow channels 145A, 145B varies along the flow paths, thinnest at the inlet ends and thickest at the outlet ends. The increase in height may be accomplished symmetrically about a cross-section of the spacer parallel to its primary plane, or the ribs may increase in height on only the upper or lower side of the spacer 130. Due to the change in cross-sectional area of the fluid flow channels 145A, 145B along their flow paths, the flow velocity decreases along the flow paths so that there is additional water splitting to enhance removal of SiO₂ and other contaminants with the greater associated contact time of aqueous solution flowing through the fluid flow channels 145A, 145B and the ion exchange membranes or beads bordering or included in the fluid flow channels 145A, 145B. The second plurality of flow channels 145B may change in height with distance from the second inlet port 165 at a same rate as the first plurality of flow channels 145A change in height with distance from the first inlet port 165.

Similar to the spacers of FIGS. 3-5, the spacer of FIG. 6 includes two inlet ports 165 and a centrally located manifold 175. The manifold 175 is in series fluid communication with the first plurality of flow channels 145A between a first of the inlet ports 165 and the outlet port 170 and is configured to direct fluid in a second direction different from a first direction through the first plurality of flow channels 145A in a portion of the flow path from the first inlet port 165 to the outlet port 170. A second plurality of flow channels 145B is disposed between the manifold 175 and a second of the inlet ports 165. The manifold 175 is in series fluid communication with the second plurality of flow channels 145B between the second of the inlet ports 165 and the outlet port 170 and is configured to direct fluid in a second direction different from a first direction through the second plurality of flow channels 145B in a portion of a flow path from the first inlet port 165 to the outlet port 170.

To provide for a concentrate spacer, for example, an upper surface of a concentrate spacer to be disposed against a lower surface of a dilute spacer and to appropriately mate against the dilute spacer when the dilute space has ribs that change in height along their flow paths as illustrated in FIG. 6, the concentrate spacer 125 may include a third and/or fourth plurality of flow channels 145C, 145D having dimensions complimentary to dimensions of the first and/or second plurality of flow channels 145A, 145B of the dilute spacer 130. An example of such a concentrate spacer is illustrated in FIG. 7. As shown in FIG. 7 the height of the ribs 150 of the concentrate spacer 125 decrease in height with distance from an outer region of the spacer to an inner region of the spacer so that they may mate against the ribs 150 of the dilute spacer 130 of FIG. 6, with an intervening ion exchange membrane, with little or no gaps. The thickness of the concentrate compartments also varies, but in the opposite direction as the dilute compartments so that dilute and concentrate spacers can be stacked up without leaving gaps between their respective ribs.

As discussed generally above, one or more of the first plurality of flow channels, the second plurality of flow channels, the third plurality of flow channels, or the fourth plurality of flow channels 145A-145D may include beads of anion and cation ion exchange resin each having a bimodal size distribution. The dilute spacer 130 and the concentrate spacer 125 may form a cell pair exhibiting an electrical conductivity at least 20% higher than the conductivity of a cell pair including the dilute spacer 130 and concentrate spacer 125 each including only anion exchange resin beads with uniform sizes and cation exchange resin beads with uniform sizes.

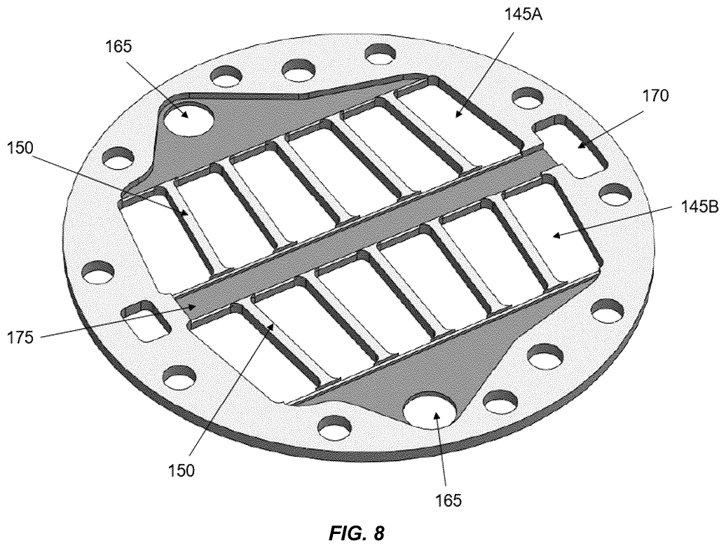

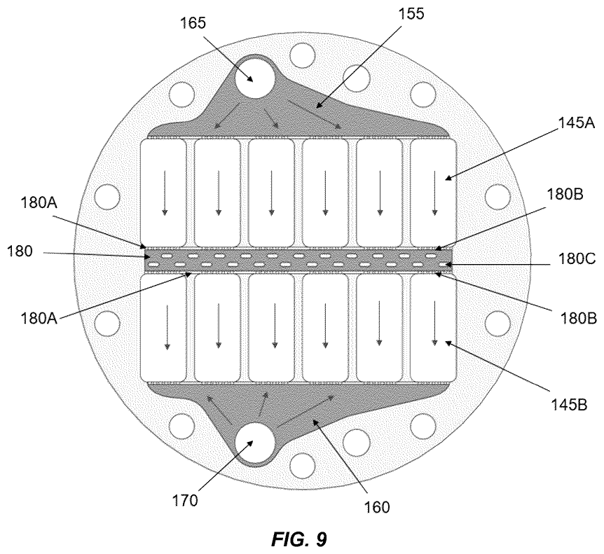

In addition or as an alternative to increasing in cross-sectional area along their flow paths by increasing in height with distance from the inlet ports 165, the first and/or second plurality of fluid flow channels 140A, 140B may increase in width along their flow paths with distance from the inlet ports 165. This will also result in a reduced fluid flow velocity with distance through the fluid flow channels 140A, 140B to increase residence time and allow more time for ionic species to pass out of the dilute spacer as the fluid undergoing treatment becomes less concentrated in the ionic species. As illustrated in FIG. 8, this may be accomplished by making the walls 150 of the first and/or second plurality of flow channels 140A, 140B non-parallel. The walls 150 of the first and/or second plurality of flow channels 140A, 140B are disposed at angles relative to one another and diverge, thus increasing the width of the first and/or second plurality of flow channels 140A, 140B along their flow paths with distance from the inlet ports 165. This change in width of the fluid flow channels with distance both decreases the fluid flow velocity and increases the surface area of the ion exchange membranes 135, 140 bordering the fluid flow channels 145A, 145B with distance from inlets of the fluid flow channels 145A, 145B. Both of these factors may provide for increased transport of ionic contaminants from the dilute spacer 130 into the concentrate spacer 125.

In other embodiments, cross-sectional areas of the first plurality of fluid flow channels 145A and/or second plurality of fluid flow channels 145B may remain substantially the same with distance from the first and/or second inlet ports 165, and at least one of widths or heights of the first and/or second plurality of flow channels 145A, 145B may change with distance from the first and/or second inlet ports 165. For example, if the widths of the fluid flow channels 145A, 145B increase with distance from inlets of the flow channels, this still provides the benefit of increased ion exchange membrane area bordering the fluid flow channels 145A, 145B. Ionic transport out of the dilute spacer 130 and into the concentrate spacer 125 may thus be enhanced with distance along the fluid flow channels 145A, 145B, even though the fluid flow velocity remains substantially constant along the fluid flow channels 145A, 145B

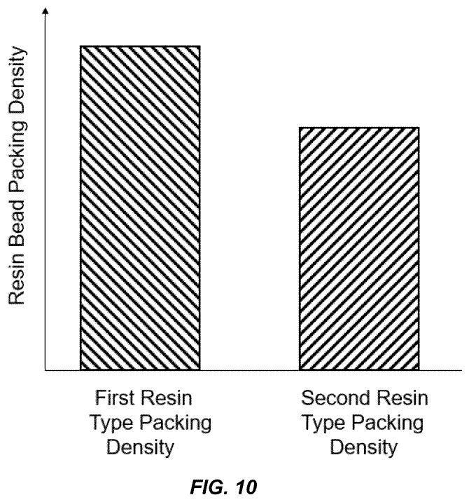

It has been appreciated that when a dilute spacer is provided with a plurality of flow channels 145A through with an aqueous solution to be purified flows in parallel, some of the flow channels may exhibit different flow resistances than others, leading to different residence times of the aqueous solution in the different flow channels of the plurality of flow channels 145A. This may result in different amounts of contaminants being removed from the aqueous solution in the different flow channels. For example, one of the flow channels of the plurality of flow channels 145A may include ion exchange resin beads that have non-uniformly compacted, providing for channeling through the flow channel, resulting in reduced residence time and reduced time for purification of the aqueous solution to be performed than in others of the plurality of flow channels 145A. In systems where a two-stage treatment through flow channels arranged in series is performed, it may be desirable to mix the aqueous solution output from the first plurality of parallel flow channels 145A so that the concentration of impurities in any aqueous solution that was not as well purified in one of the flow channels as aqueous solution in the other flow channels may be reduced in the mixed solution prior to further treatment in the downstream fluid flow channels. A spacer providing for such mixing of aqueous solution output from parallel fluid flow channels is illustrated in FIG. 9. In the spacer of FIG. 9 aqueous solution or fluid to be treated (also referred to as feed water) is introduced from an inlet port 165 through an inlet manifold 155 into a first plurality of flow channels 145A arranged in parallel and passes through the first plurality of flow channels 145A. A mixing zone 180 is disposed fluidically between the first plurality of flow channels 145A and a second plurality of flow channels 145B. The mixing zone 180 is configured to receive fluid from each of the first plurality of flow channels 145A and direct the fluid into each of the second plurality of flow channels 145B. The treated fluid is then directed through an outlet manifold 160 and is collected in an outlet port 170. The mixing zone 180 distributes partially treated fluid from each of the first plurality of flow channels 145A into each of the second plurality of flow channels 145B. This embodiment does not increase the flow rate per spacer, but improves the deionization performance with a “two-pass” process. With appropriately sized and selected resins the deionization performance of each pass (flow through one set of channels) is comparable to that of the of dilute spacer of the current art. In addition, remixing of the effluent from the first pass can counter possible variations in deionization from channel to channel and can result in improved deionization in the second pass.

The mixing zone 180 includes at least one wall 180A disposed between the first plurality of flow channels 145A and second plurality of flow channels 145B. The wall 180A has a plurality of apertures 180B configured to disrupt laminar flow and facilitate mixing of fluid in the mixing chamber 180. The mixing zone 180 may include one wall 180A that defines downstream ends of the first plurality of flow chambers 145A. The first plurality of flow channels 145A may include beads of ion exchange resin and the plurality of apertures 180B in the wall 180A defining the downstream ends of the first plurality of flow channels 145A may have dimensions smaller than the beads of ion exchange resin to keep the beads of ion exchange resin from moving from the first plurality of flow channels 145A into the mixing zone 180. The mixing chamber 180 may include internal structures 180C, for example, posts or baffles, configured to promote mixing of fluid introduced into the mixing chamber 180 from the first plurality of flow channels 145A.

The mixing chamber 180 may further include a second wall 180A disposed between the first plurality of flow channels 145A and second plurality of flow channels 145B. The second wall 180A may have a second plurality of apertures 180B. The second wall 180A may define upstream ends of the second plurality of fluid channels 145B. The second plurality of flow channels 145B may include beads of ion exchange resin and the second plurality of apertures 180B may have dimensions smaller than the beads of ion exchange resin to keep the beads of ion exchange resin from moving from the second plurality of flow channels 145B into the mixing zone 180. The apertures 180B in the second wall 180A may also slow fluid flow out of the mixing zone 180 to facilitate mixing of the effluent from the first plurality of flow channels 145A and a more even distribution of the mixed effluent into each individual one of the second plurality of flow channels 145B.

As illustrated in FIG. 9, the first plurality of flow channels 145A and the second plurality of flow channels 145B are equal in number, each of the first plurality of flow channels 145A is aligned with a corresponding one of the second plurality of flow channels 145B, and the first plurality of flow channels 145A and the second plurality of flow channels 145B have substantially same dimensions. As used herein with reference to the dimensions of the flow channels, 145A, 145B, the term “substantially the same” may mean the same except for differences due to variability inherent to the manufacturing process for the spacer. In other embodiments, the first plurality of flow channels 145A and the second plurality of flow channels 145B may be different in number, and/or not aligned with one another, and/or may have different dimensions.

A direction of fluid flow through the first plurality of flow channels 145A may be substantially parallel to a direction of fluid flow through the second plurality of flow channels 145B. As used herein with reference to the direction of fluid flow through the flow channels, the term “substantially parallel” may mean parallel except for deviations due to pressure differences associated with placement of the inlet and outlet ports 155, 160 or other asymmetries of the spacer. A velocity of fluid flow through the first plurality of flow channels 145A may be substantially the same as a velocity of fluid flow through the second plurality of flow channels 145B, for example, the same subject to differences arising from pressure differences associated with placement of the inlet and outlet ports 155, 160 or other asymmetries of the spacer. In other embodiments, velocity of fluid flow through the second plurality of flow channels 145B may be slower than the velocity of fluid flow through the first plurality of fluid flow channels 145A to provide for increased residence time to remove ionic impurities from the fluid in the second plurality of flow channels 145B. This may be beneficial because the fluid flowing through the second plurality of fluid flow channels 145B may have a lower concentration of ionic impurities than fluid flowing through the first plurality of fluid flow channels 145A. This decrease in velocity may be accomplished by increasing the cross-sectional areas of the second plurality of fluid flow channels 145B relative to the first plurality of fluid flow channels 145A, for example, by forming the second plurality of fluid flow channels 145B with greater widths or greater heights than the first plurality of fluid flow channels 145A.

The mixing zone 180 may have a width in an average direction of fluid flow through the mixing zone 180 that is less than widths of the first plurality of flow channels 145A and/or second plurality of flow channels 145B in a direction perpendicular to an average direction of fluid flow through the first plurality of flow channels 145A and/or second plurality of flow channels 145B. The width of the mixing zone 180 may substantially constant across a length of the mixing zone 180, for example, subject to differences in width due to variability inherent to the manufacturing process for the spacer. The mixing zone 180 may have a length in a direction perpendicular to an average direction of fluid flow through the mixing zone 180 that is greater than lengths of the first plurality of flow channels 145A and/or second plurality of flow channels 145B in an average direction of fluid flow through the first plurality of flow channels 145A and/or second plurality of flow channels 145B. The length of the mixing zone 180 may be substantially constant across a width of the mixing zone 180, for example, subject to differences in length due to variability inherent to the manufacturing process for the spacer.

EDI devices can be used for general deionization of feed water with, for example, 50-100 μS/cm conductivity to a product with, for example, 1-10 μS/cm conductivity. Strongly dissociated ions are removed at near neutral pH in typical implementations. Ion migration across the compartment under an applied DC electric field is assumed to be primarily along the surface of the ion exchange resins and not inside the resins or in the fluid in the interstices between the resins.

Many implementations of EDI devices, however, are for production of ultrapure water, with resistivity up to >18 MΩ-cm. Removal of weak acids such as dissolved boron, silica and CO₂ is performed. Particle diffusion within the resins becomes a significant transport mechanism, and can be promoted by methods such as:
Use of low cross-linked resins beads and membranes;
Heterogeneous membranes to increase localized current at the membrane surface and thus locally more water splitting to produce local pH shifts;
Mixtures of strong and weak ion exchange resins; and/or
Addition of Type II anion resins.

To maintain deionization performance at higher flow rate, one method is to use resins of smaller diameters than in the current state of the art dilute spacers so that the total surface area of the resin beads in a spacer is higher than that in the current state of the art spacers. An equation to estimate the ratio of surface area in a high flow spacer as disclosed herein vs. a VNX™ EDI device spacer is as follows:

$$\frac{{S}_{1}}{{S}_{2}} = \frac{{ε}_{2} {V}_{2}}{{ε}_{1} {V}_{1}} [ \frac{{r}_{1}}{{r}_{2}} ]$$

### Where:

ε=packing density=fraction of channel volume occupied by resins (0.64 for close random packing, for example)
V=volume in channels
N=number of resin beads in channel
r=average radius of a bead
S=surface area on each bead
Suffix 1 for current VNX™ EDI device spacer
Suffix 2 for high flow spacer

Assuming that the resins are of uniform size distribution:
600 μm diameter in current VNX™ EDI device modules
250 μm in high flow design concept

$$and$$

$${ε}_{1} = {ε}_{2}$$

$$\begin{matrix}{V}_{1} = 29.68 {in}^{3} ( 486.4 {cm}^{3} ) \\ {V}_{2} = 27.53 {in}^{3} ( 451.1 {cm}^{3} )\end{matrix}$$

$$\frac{{S}_{1}}{{S}_{2}} = 2.2$$

Doubling the total surface area on resin beads does not automatically mean that the flow rate can be doubled. The flow rate can certainly be increased. The percentage increase may be determined experimentally, since not all resins available are of uniform size distribution and resin properties differ from one resin type to another.

The smaller resins will increase the pressure drop per unit length of fluid flow channel, but since the fluid flow channel lengths of high flow spacers as disclosed herein may be shorter than in the VNX™ EDI device module spacers, the overall pressure drop per spacer may not vary significantly. Again, the pressure drop characteristic of the high flow spacer may be determined experimentally.

In a cylinder filled with spherical ion exchange resin beads of uniform diameter, the local void fraction will be highest at the walls, and the resistance to fluid flow would be lowest. The fluid to be deionized would therefore preferentially flow next to the surfaces of the membranes and bypass the bulk resin bed. This “wall effect” can reduce the deionization performance; the distance that the wall effect extends from the walls depends on the type of packing (from hex close packing to random) and is typically on the order of several multiples of bead diameter. The fraction of total flow that bypasses the bulk resin bed is lowest in resin beds with the smallest diameter resins.

In an EDI device the resins are packed between parallel flat walls (membranes). Smaller ion exchange resin beads would reduce the wall effect.

If, however, the number of beads in a spacer fluid flow channel between membranes is constant, then the relative porosity is likely closer to the same for large and small beads, with the advantage of small beads being thinner boundary layers (for both fluid flow and diffusion). Having more flow along the membrane surface may not be harmful as long as there is water splitting at the membrane (especially with heterogeneous membranes) and lower size of voids using smaller beads.

Lower inter-membrane spacings may be advantageous in beds with mixed cation and anion resins, because as the number of beads between membranes increase above three, the frequency of dead ends in current transport across the beads increases.

The fluid flow channels in spacers of EDI devices can be filled with resins with a bimodal size distribution. The diameters can be selected so that the smaller diameter beads fit in the interstices between the larger beads. The objectives are to:
Increase the packing density and the surface area of resin beads per unit volume;
Improve electrical conductivity in the resin bed;
Allow larger inter-membrane distances without running into 3-bead limitations; and
Reduce wall effect at the membranes.

In some embodiments, the performance of EDI devices, including reduction in liquid channeling and wall effects as well as increase in the conductivity of resin beds in the fluid flow channels of the EDI device spacers may be achieved by selection of a distribution of resin bead sizes within the fluid flow channels. Such performance improvements may be implemented in any of the embodiments of EDI device spacers disclosed herein. Such performance improvements may be implemented in, for example, an electrodeionization device including a spacer comprising an inlet port, an outlet port, a first plurality of flow channels configured to direct fluid along a portion of a fluid flow path from the inlet port to the outlet port, and a second plurality of flow channels configured to direct fluid along a second portion of the fluid flow path from the inlet port to the outlet port. The second plurality of flow channels may be in series with the first plurality of flow channels, for example, in the embodiment shown in FIG. 9. The second plurality of flow channels may be configured to flow fluid in an opposite direction from a direction of fluid flow through the first plurality of flow channels, for example, in the embodiments shown in FIGS. 4A-6 and 8.

Ion exchange media beads are disposed within each of the first plurality of flow channels and the second plurality of flow channels. A size distribution of the ion exchange media beads may change from an inlet to an outlet of the first plurality of flow channels, from an inlet to an outlet of the second plurality of flow channels, or from the first plurality of flow channels to the second plurality of flow channels.

The ion exchange media beads may form mixed beds including cation exchange media beads and anion exchange media beads. In some embodiments, the cation exchange media beads have a different size distribution, for example, a size distribution with a different mean, median, or variance, than the anion exchange media beads. The first plurality of flow channels or the second plurality of flow channels may include different number ratios of the cation exchange media beads to the anion exchange media beads. Either or both of the first plurality of flow channels or the second plurality of flow channels may include a substantially same total surface area of the cation exchange media beads and the anion exchange media beads. The term “substantially same” used with respect to comparison of the total surface area of the cation exchange media beads and the anion exchange media beads may be understood to mean that variability inherent to a manufacturing process for the spacers and EDI devices may result in different total surface areas for the two ion exchange bead types even though a same total surface area was intended. In other embodiments, mixed beds of ion exchange resin beads in either or both of the first plurality of flow channels or the second plurality of flow channels in an EDI device spacer as disclosed herein may include a substantially equal number of cation exchange media beads and anion exchange media beads (an equal number subject to manufacturing variability) or a substantially equal volume of cation exchange media beads and anion exchange media beads (an equal volume subject to manufacturing variability).

One of the first plurality of flow channels or the second plurality of flow channels may include cation exchange media beads having a first packing density and anion exchange media beads having a second packing density different from the first packing density as illustrated in FIG. 10. In some embodiments the cation exchange media beads have a greater packing density than the anion exchange media beads and in other embodiments the anion exchange media beads have a greater packing density than the cation exchange media beads. In further embodiments, the anion and cation exchange media beads in fluid flow channels of an EDI device spacers may have substantially the same packing density, subject to manufacturing variability.

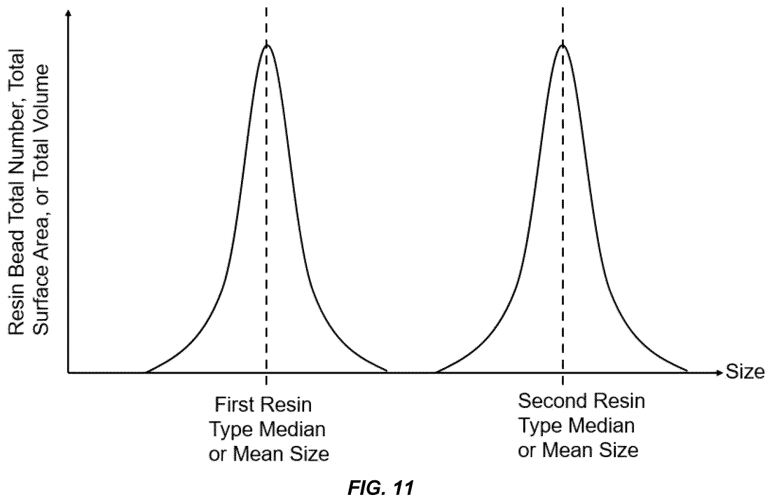

One of the first plurality of flow channels or the second plurality of flow channels may include cation exchange media beads having a first unimodal size distribution with a first median size and anion exchange media beads having a second unimodal size distribution with a second median size different from the first median size. As the term is used herein a unimodal size distribution refers to a size distribution having a mean or median and a spread in sizes associated with, for example, manufacturing variability. The two unimodal size distributions may be, for example, Gaussian distributions as illustrated in FIG. 11 although the size distributions may be skewed from perfect Gaussian distributions or be of different distribution types and the total number, total surface area, and/or total volume of the different resin types may be the same or different. In other embodiments, the size distributions of the anion and cation exchange media beads may be substantially the same, subject to manufacturing variability.

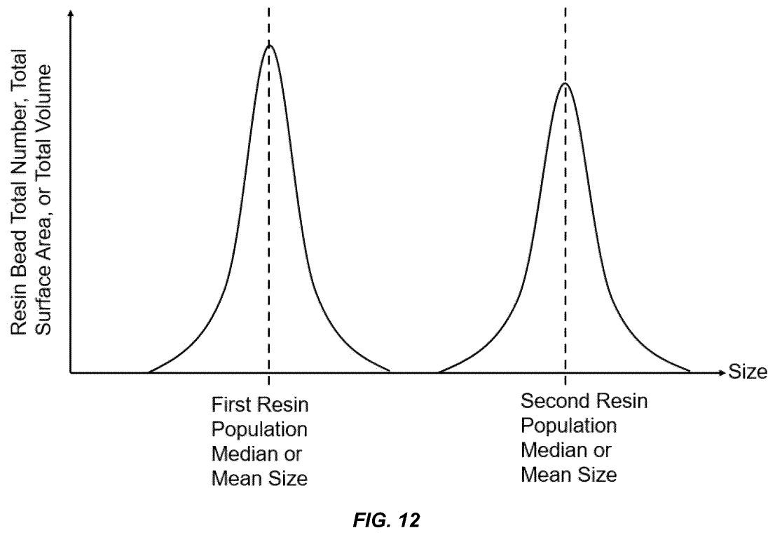

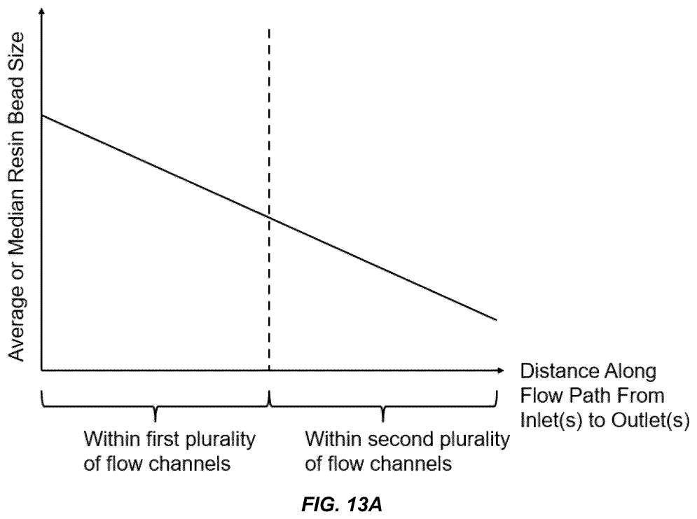

In some embodiments, the first plurality of flow channels or the second plurality of flow channels may include cation exchange media beads and/or anion exchange media beads having a bimodal size distribution. As used herein a bimodal resin bead size distribution means that the resin beads include two populations, one with a first mean or median size and size spread and one with a second mean or median size and size spread, for example, as illustrated in FIG. 12. The size distributions may be skewed from perfect Gaussian distributions or be of different distribution types and the total number, total surface area, and/or total volume of the different resin size populations may be the same or different.

The cation exchange media beads and the anion exchange media beads in the first plurality of flow channels and/or the second plurality of flow channels may collectively increase in volume during use of the electrodeionization device as compared to when initially packed into the first and/or second plurality of flow channels and decrease a void volume within the first and/or second plurality of flow channels by at least 5% or in other embodiments by at least 2% or at least 10%.

In some embodiments the cation exchange media beads include larger beads having substantially same sizes and smaller beads having substantially same sizes, again as illustrated schematically in FIG. 12. As the term is used herein resin beads with “substantially same sizes” refers to a resin bead size distribution having a single mean or median and a spread in sizes associated with, for example, manufacturing variability.

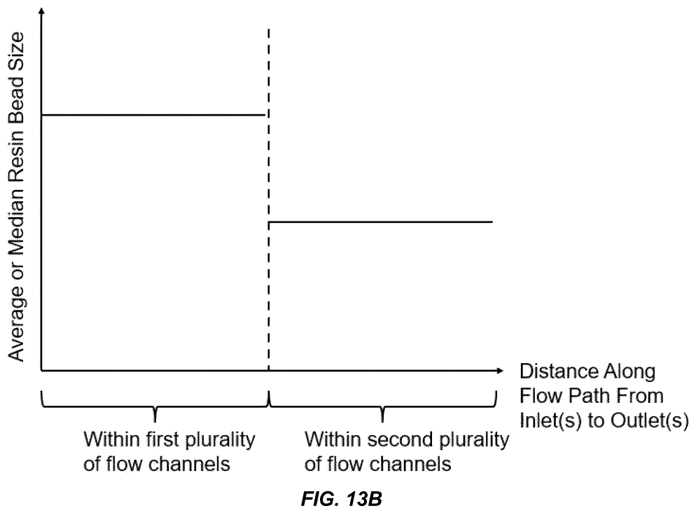

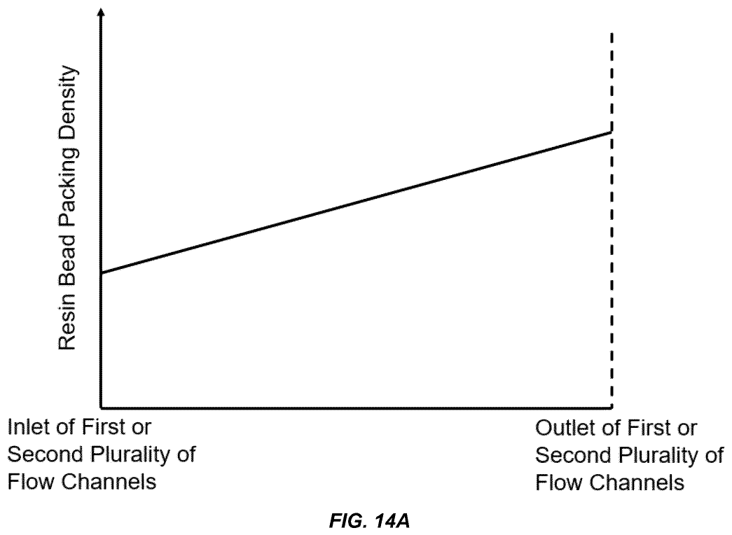

The first and second pluralities of flow channels may be arranged in series, for example as illustrated in FIG. 8 and an average size of the ion exchange media beads may decrease with distance along a flow path through the first and second pluralities of flow channels as schematically illustrated in FIGS. 13A and 13B. This may facilitate increased ionic transport kinetics from the flow channels of the dilute spacers into the flow channels of the concentrate spacers to compensate for the reduced ionic concentration in fluid undergoing treatment with distance through the fluid flow channels of the dilute spacers. The average size of the ion exchange media beads may decrease with distance smoothly along the flow path through the first and second pluralities of flow channels as schematically shown in FIG. 13A or include a step function when transitioning from the first to the second plurality of flow channels as schematically shown in FIG. 13B. The second plurality of flow channels may be disposed downstream of the first plurality of flow channels and an average size of the ion exchange media beads may be smaller in the second plurality of flow channels than in the first plurality of flow channels. An average size of the ion exchange media beads may decrease with distance along a flow path through one of the first plurality of flow channels or the second plurality of flow channels, again as illustrated schematically in FIG. 13A.

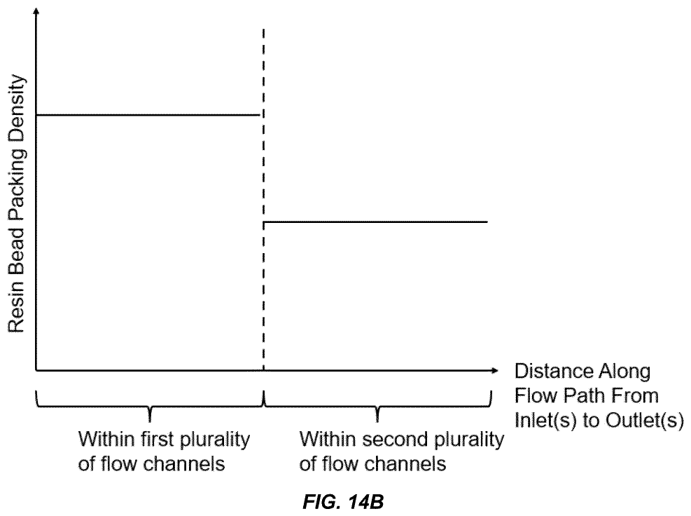

The packing density of the ion exchange media beads may change, for example, increase from an inlet to an outlet of the first plurality of flow channels as schematically illustrated in FIG. 14A. The packing density of the ion exchange media beads may change, for example, increase from an inlet to an outlet of the second plurality of flow channels as schematically illustrated in FIG. 14A. The packing density of the ion exchange media beads may change, for example, increase from the first plurality of flow channels to the second plurality of flow channels as schematically illustrated in FIG. 14B. The change in packing density may be continuous or step-wise and may be an increase or decrease in packing density. These changes in packing density may facilitate increased ionic transport kinetics from the flow channels of the dilute spacers into the flow channels of the concentrate spacers to compensate for the reduced ionic concentration in fluid undergoing treatment with distance through the fluid flow channels of the dilute spacers. In other embodiments where it may be desirable to decrease flow resistance with length through a flow channel or through series arranged first and second pluralities of flow channels, the ion exchange resin bead packing density may decrease with distance through one or both of the first and second plurality of flow channels.

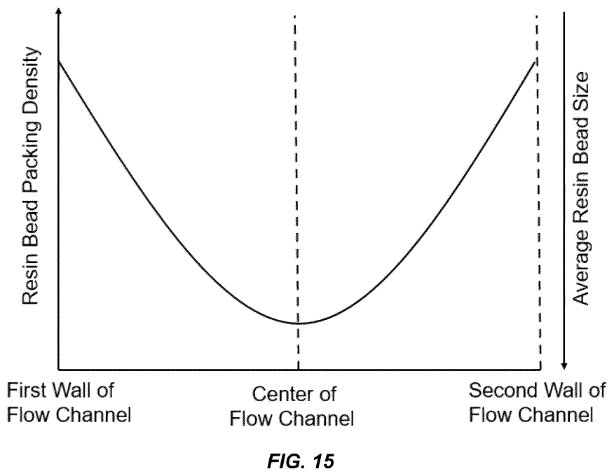

The packing density of the ion exchange media beads may be higher proximate walls than proximate central regions of one of the first plurality of flow channels or the second plurality of flow channels as schematically illustrated in FIG. 15. The walls may be the walls 150A of the ribs 150 separating the flow channels, or may be membranes 135, 140 on the top or bottom of the flow channels. This may help prevent wall effects that could otherwise result in channeling of fluid through the flow channels near their walls. In some embodiments, beads of anion and cation ion exchange resin proximate walls of the first and/or second plurality of first flow channels may have a smaller average size than beads of anion and cation ion exchange resin proximate centers of the first plurality of first flow channels and distal from the walls of the first and/or second plurality of first flow channels to facilitate increasing the packing density proximate the walls.

In EDI devices including a mixing zone, for example, as illustrated in FIG. 8, the first plurality of flow channels 145A may include beads of anion and cation ion exchange resin having a greater average size than beads of anion and cation ion exchange resin included in the second plurality of flow channels 145B. The first plurality of flow channels 145A may include beads of anion and cation ion exchange resin each having a unimodal size distribution. The second plurality of flow channels 145B may include beads of anion and cation ion exchange resin each having a bimodal size distribution.

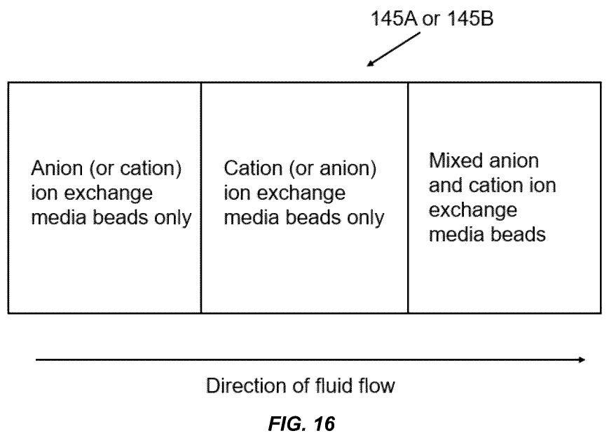

In some embodiments, in any of the spacers disclosed herein one of the first plurality of flow channels 145A or the second plurality of flow channels 145B may include a layer of cation ion exchange resin only, a layer of anion exchange resin only, and a layer of mixed anion and cation ion exchange resin. The layering of the ion exchange media beads may be in a direction of fluid flow through the flow channels. This is illustrated schematically in FIG. 16. In different embodiments, the different layers may occur in different orders along the flow path through the flow channels and the layers may have the same or different widths along the flow path.

In various embodiments disclosed herein the anion exchange membranes 135 and/or cation exchange membranes 140 (collectively referred to as ion exchange membranes 135, 140) disposed between adjacent spacers may include surface features that increase the surface area of the membranes and/or facilitate more even or more dense packing of ion exchange membrane beads against surfaces of the ion exchange membranes. These features may include protrusions, recesses, or ribs. Such ion exchange membranes maybe referred to herein as profiled ion exchange membranes. Profiled ion exchange membranes 135,140 may be utilized in any of the embodiments disclosed herein. The increased surface area of profiled ion exchange membranes as compared to ion exchange membranes with flat surfaces may facilitate increased ionic transport into and through the profiled ion exchange membranes. The profiled ion exchange membranes may thus increase a rate at which ionic contaminants are transported from fluid in the flow channels of dilute spacers into fluid in the flow channels of concentrate spacers.

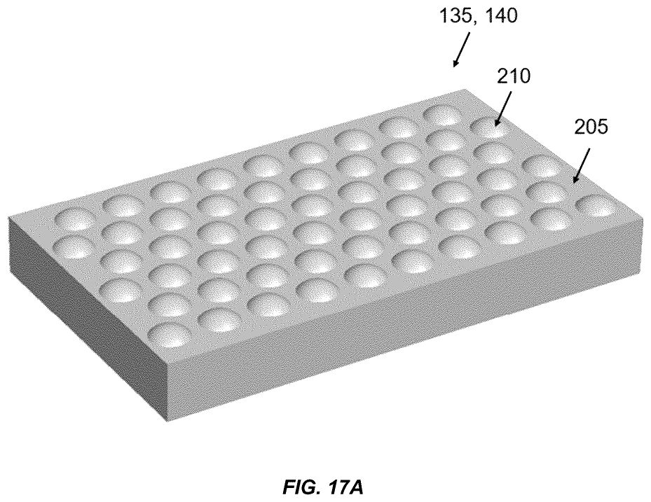

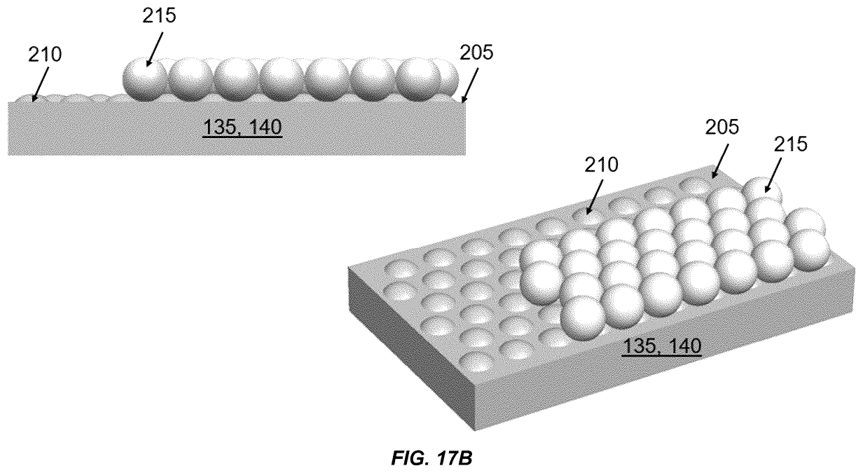

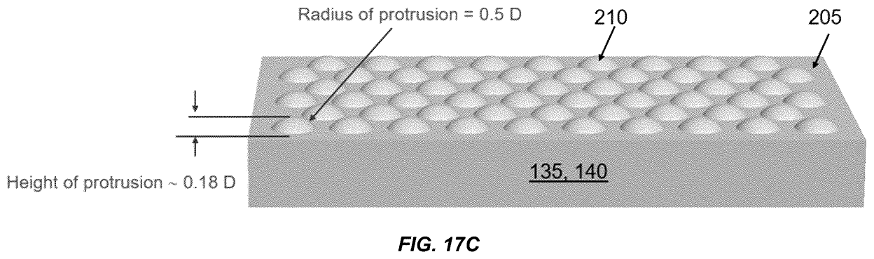

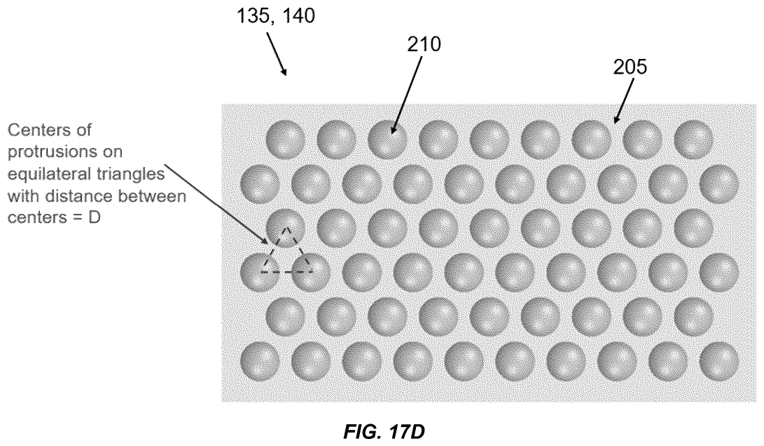

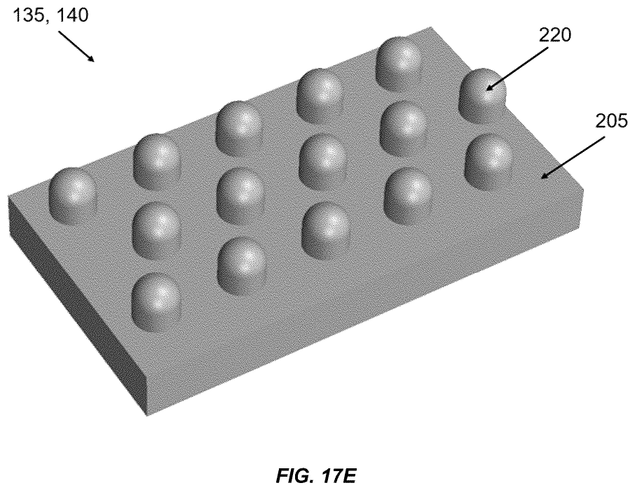

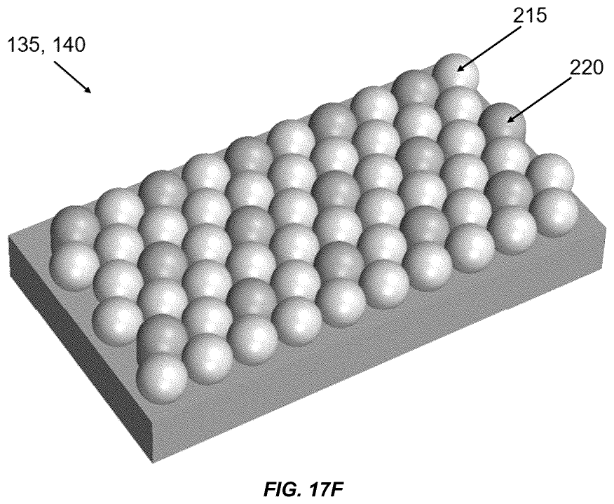

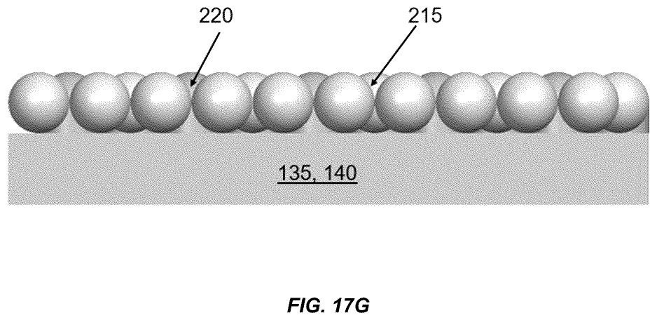

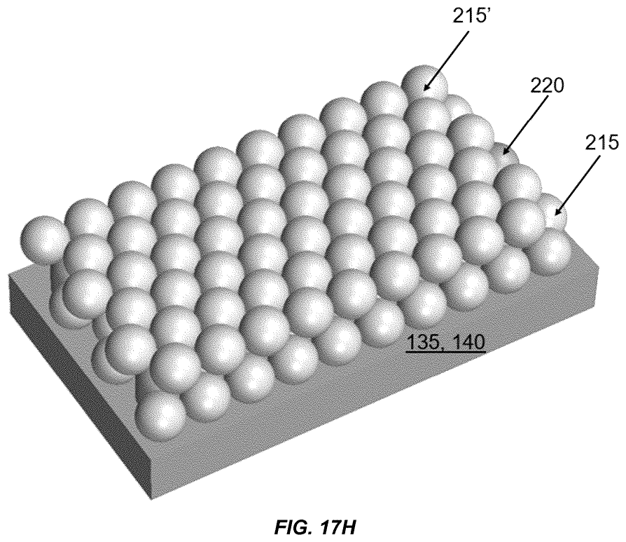

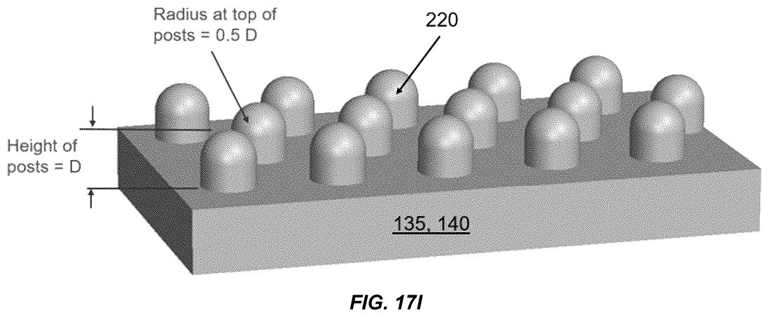

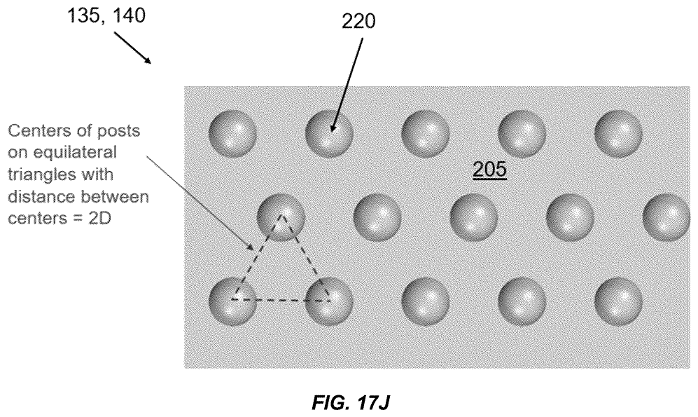

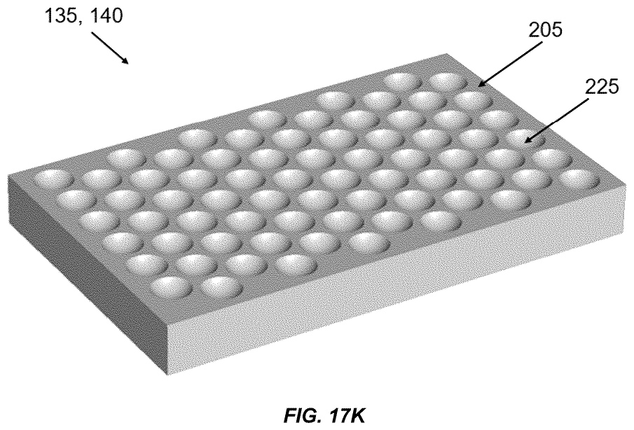

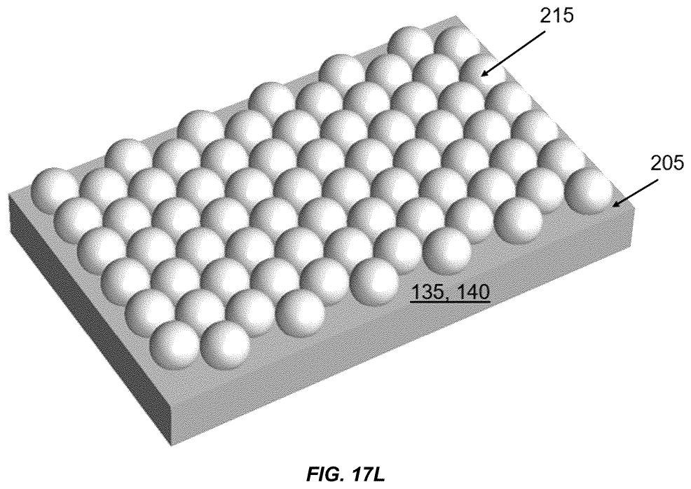

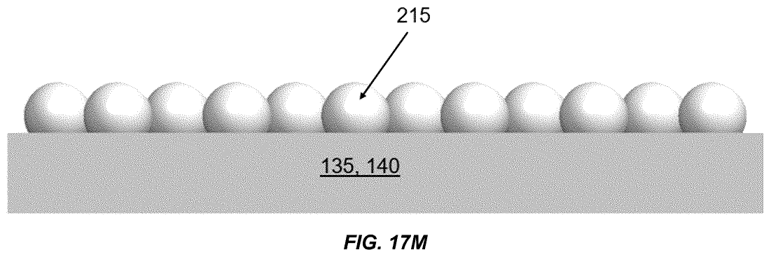

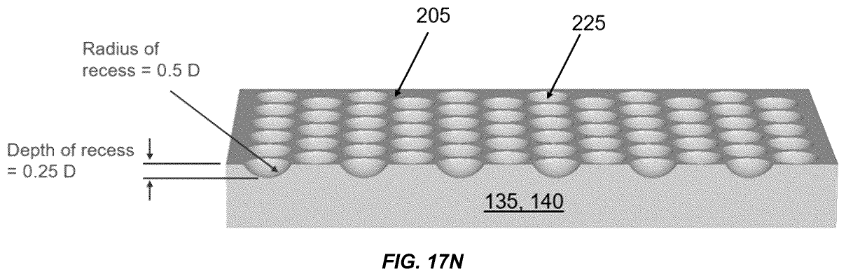

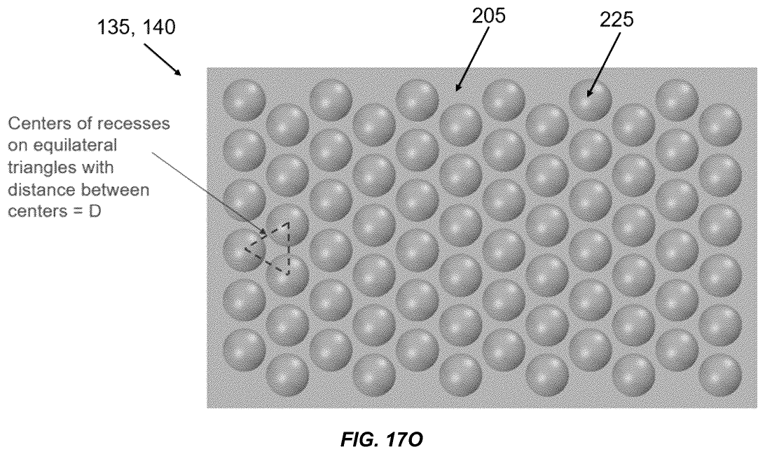

One example of a portion of a profiled ion exchange membrane 135, 140 is illustrated in FIG. 17A. The profiled ion exchange membrane includes a plurality of protrusions in the form of partial spheres 210 extending from its surface 205. In some embodiments, the partial spheres, or other surface features described herein, may be present on both sides of the profiled ion exchange membrane. The partial spheres 210 are illustrated as being disposed in a regular array, but in other embodiments, the partial spheres may be arranged in an irregular or even random distribution. As illustrated in FIG. 17B, the partial spheres 210 block gaps between beads of ion exchange resin 215 and the profiled ion exchange membrane 135, 140 in addition to increasing the surface area of the profiled ion exchange membrane 135, 140. This may provide for faster kinetics of ionic transport from the beads of ion exchange resin 215 into the profiled ion exchange membrane 135, 140 because of the increased contact area between the beads of ion exchange resin 215 and the profiled ion exchange membrane 135, 140.

The partial spheres 210 may have dimensions of about 0.18D high with radii of 0.5D, where D is the mean or median diameter of beads of ion exchange resin 215 in an EDI spacer fluid flow chamber that the surface 205 of the profiled ion exchange membrane 135, 140 faces as shown in FIG. 17C. The partial spheres 210 may be spaced such that centers of the partial spheres 210 lie on the vertices of equilateral triangles with distance between centers=D as illustrated in FIG. 17D.

In another embodiment, illustrated in FIG. 17E, the protrusions on the surface of the profiled ion exchange membrane 135, 140 are in the form of posts 220 with rounded tops. The rounded tops of the posts 220 may have radii comparable to or equal to some or all of the beads of ion exchange resin in the fluid flow chamber that the surface of the profiled ion exchange membrane 135, 140 faces or to a mean or median radius of the beads of ion exchange resin. The posts 220 may be spaced to promote hexagonal close packing of the beads of ion exchange resin 215 on the surface 205 of the profiled ion exchange membrane 135, 140, as illustrated in FIG. 17F. This may help maximize the packing density of the beads of ion exchange resin 215 on or proximate the surface 205 of the profiled ion exchange membrane 135, 140 and/or throughout the fluid flow chamber that the surface of the profiled ion exchange membrane 135, 140 faces. The posts 220 may also block gaps between first layer of ion exchange resin beads 215 and the profiled ion exchange membrane 135, 140 as shown in FIG. 17G. This may provide for faster kinetics of ionic transport from the beads of ion exchange resin 215 into the profiled ion exchange membrane 135, 140 because of the increased contact area between the beads of ion exchange resin 215 and the profiled ion exchange membrane 135, 140. Once the first layer of ion exchange resin beads 215 assumes a hexagonal close packed arrangement, additional layers of ion exchange resin beads 215′ deposited on the first layer will also assume a hexagonal close packed arrangement, as illustrated in FIG. 17H.

The posts 220 may have dimensions of about D high with radii of the rounded top portions of the posts of 0.5D, where D is the mean or median diameter of beads of ion exchange resin 215 in an EDI spacer fluid flow chamber that the surface 205 of the profiled ion exchange membrane 135, 140 faces as shown in FIG. 17I. The posts 220 may be spaced such that centers of the posts 220 lie on the vertices of equilateral triangles with distance between centers=2D as illustrated in FIG. 17J.

In another embodiment, illustrated in FIG. 17K, a profiled ion exchange membrane 135, 140 may include a plurality of recesses 225. The recesses 225 may have radii comparable to or equal to some or all of the beads 215 of ion exchange resin in the fluid flow chamber that the surface of the profiled ion exchange membrane 135, 140 faces or to a mean or median radius of the beads of ion exchange resin. The recesses 225 may be spaced from one another to promote hexagonal close packing of beads 215 of ion exchange resin on the surface 205 of the profiled ion exchange membrane 135, 140, as illustrated in FIG. 17L. This may help maximize the packing density of the beads of ion exchange resin 215 on or proximate the surface 205 of the profiled ion exchange membrane 135, 140 and/or throughout the fluid flow chamber that the surface of the profiled ion exchange membrane 135, 140 faces. Embedding the resin beads 215 into the membrane surface 205, as illustrated in FIG. 17M, reduces gaps for flow between the beads 215 and the membrane 135, 140 which may provide for faster kinetics of ionic transport from the beads of ion exchange resin 215 into the profiled ion exchange membrane 135, 140 because of the increased contact area between the beads of ion exchange resin 215 and the profiled ion exchange membrane 135, 140.

The recesses 225 may have depths of about 0.25D and radii of 0.5D, where D is the mean or median diameter of beads of ion exchange resin 215 in an EDI spacer fluid flow chamber that the surface 205 of the profiled ion exchange membrane 135, 140 faces as shown in FIG. 17N. The recesses 225 may be spaced such that centers of the recesses 225 lie on the vertices of equilateral triangles with distance between centers=D as illustrated in FIG. 17O.

In various embodiments, increasing the flow rate per spacer may be performed along with an increase in the applied current to achieve the same deionization performance. If the electrical resistances across the membranes and the ion exchange media do not change, increasing the current may accompany an increase in the DC voltage applied across the electrodes and therefore an increase in energy consumption.

One method of reducing the impact of increased current is to reduce the electrical resistance in the membranes by utilizing thinner membranes. For example, reducing the thickness of extruded heterogeneous membranes from 0.02 in (0.051 cm) to 0.014 in (0.036 cm) results in a 25% reduction in overall resistance in a LX™ EDI device manufactured by Evoqua Water Technologies.

Aspects and embodiments disclosed herein are not limited to electrodialysis apparatus. Many electrochemical separation devices may benefit from the features and methods disclosed herein. Electrochemical separation devices include but are not limited to Electrodialysis, Electrodialysis Reversal, Continuous Deionization, Continuous Electrodeionization, Electrodeionization, Electrodiaresis, and Capacitive Deionization. Other electrochemical devices that would benefit from the features and methods disclosed herein include Flow Batteries, Fuel Cells, Electrochlorination Cells and Caustic Chlorine Cells.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. An electrochemical device including a spacer comprising:
a first inlet port;
a first outlet port;
a first plurality of flow channels configured to direct fluid in a first planar direction parallel to a primary plane of the spacer in a portion of a flow path from the first inlet port to the first outlet port; and
a manifold in series fluid communication with the first plurality of flow channels between the first inlet port and first outlet port and configured to direct fluid in a second planar direction parallel to the primary plane of the spacer different from the first planar direction in another portion of the flow path from the first inlet port to the first outlet port.

2. The electrochemical device of claim 1, further comprising:
an inlet manifold in series fluid communication between the first inlet port and the first plurality of flow channels and configured to direct fluid in a third planar direction parallel to the primary plane of the spacer and different from the first and second planar directions; and
an outlet manifold in series fluid communication between the first outlet port and the first plurality of flow channels and configured to direct fluid in the third planar direction.

3. The electrochemical device of claim 2, wherein the manifold is disposed along a diameter of the spacer.

4. The electrochemical device of claim 2, wherein the first plurality of flow channels is disposed between the manifold and the first inlet.

5. The electrochemical device of any one of claims 1-4, further comprising a second inlet.

6. The electrochemical device of claim 5, wherein the second inlet is on a substantially opposite side of the spacer from the first inlet.

7. The electrochemical device of claim 5, wherein the second plurality of flow channels is disposed between the manifold and the second inlet.

8. The electrochemical device of claim 7, wherein a direction of fluid flow through the first plurality of flow channels is substantially opposite to a direction of fluid flow through the second plurality of flow channels.

9. The electrochemical device of claim 7, wherein a direction of fluid flow through the manifold is substantially perpendicular to the direction of fluid flow through the first plurality of flow channels and the direction of fluid flow through the second plurality of flow channels.

10. The electrochemical device of any one of claims 1-4, wherein the manifold includes a wall disposed at an acute angle relative to an average direction of fluid flow through the manifold.

11. The electrochemical device of claim 10, wherein the manifold includes two walls each disposed at acute angles relative to the average direction of fluid flow through the manifold.

12. The electrochemical device of claim 4, wherein the manifold increases in cross-sectional area from an end furthest from the first outlet port to an end closest to the first outlet port.

13. The electrochemical device of claim 12, wherein the manifold increases in width from an end furthest from the first outlet port to an end closest to the first outlet port.

14. The electrochemical device of claim 3, wherein the first plurality of flow channels is disposed between the manifold and the first outlet.

15. The electrochemical device of claim 14, further comprising a second outlet.

16. The electrochemical device of claim 15, wherein the second outlet is on a substantially opposite side of the spacer from the first outlet.

17. The electrochemical device of claim 15, wherein the second plurality of flow channels is disposed between the manifold and the second outlet.

18. The electrochemical device of claim 17, wherein a direction of fluid flow through the first plurality of flow channels is substantially opposite to a direction of fluid flow through the second plurality of flow channels.

19. The electrochemical device of claim 17, wherein a direction of fluid flow through the manifold is substantially perpendicular to the direction of fluid flow through the first plurality of flow channels and the direction of fluid flow through the second plurality of flow channels.

20. The electrochemical device of claim 14, wherein the manifold increases in cross-sectional area from an end furthest from the first outlet port to an end closest to the first outlet port.

21. The electrochemical device of claim 20, wherein the manifold increases in width from an end furthest from the first outlet port to an end closest to the first outlet port.

22. The electrochemical device of claim 1 comprising an electrodeionization device, wherein the first plurality of first flow channels included beads of anion and cation ion exchange resin each having a bimodal size distribution.

23. The electrochemical device of claim 22, where beads of anion and cation ion exchange resin proximate walls of the first plurality of first flow channels have a smaller average size than beads of anion and cation ion exchange resin proximate centers of the first plurality of first flow channels and distal from the walls of the first plurality of first flow channels.

24. The electrochemical device of claim 22, wherein the manifold includes apertures with a smaller size than sizes of the beads of ion exchange resin.

25. An electrochemical device including a spacer comprising:
a first inlet port;
a first outlet port; and
a first plurality of flow channels configured to direct fluid in a first direction in a portion of a fluid path from the first inlet port to the first outlet port, the plurality of flow channels configured to cause a velocity of fluid flow through the first plurality of flow channels to change with distance from the first inlet port.

26. The electrochemical device of claim 25, further comprising a manifold in series fluid communication with the first plurality of flow channels between the first inlet port and first outlet port and configured to direct fluid in a second direction different from the first direction in another portion of the flow path from the first inlet port to the first outlet port.

27. The electrochemical device of claim 26, further comprising a second inlet.

28. The electrochemical device of claim 27, further comprising a second plurality of flow channels disposed between the manifold and the second inlet.

29. The electrochemical device of any one of claims 25-28, wherein cross-sectional areas of the first plurality of flow channels change with distance from the first inlet port.

30. The electrochemical device of claim 29, wherein the first plurality of flow channels change in height with distance from the first inlet port.

31. The electrochemical device of claim 30, wherein the first plurality of flow channels change in width with distance from the first input port.

32. The electrochemical device of claim 29, wherein the first plurality of first flow channels change in width with distance from the first input port.

33. The electrochemical device of claim 29, wherein walls of the first plurality of flow channels are non-parallel.

34. The electrochemical device of claim 25, wherein cross-sectional areas of the first plurality of flow channels remain substantially the same with distance from the first inlet port, and at least one of widths or heights of the first plurality of flow channels change with distance from the first inlet port.

35. The electrochemical device of any one of claims 25-34, wherein the spacer is a dilute spacer and the first plurality of first flow channels are diluting compartments.

36. The electrochemical device of any one of claims 25-35, further comprising a concentrate spacer having an upper surface disposed against a lower surface of the dilute spacer, the concentrate spacer including a third plurality of flow channels having dimensions complimentary to dimensions of the first plurality of flow channels.

37. The electrochemical device of any one of claims 25-36, comprising an electrodeionization device, wherein one or more of the first plurality of flow channels, the second plurality of flow channels, or the third plurality of flow channels include beads of anion and cation ion exchange resin each having a bimodal size distribution, the dilute spacer and the concentrate spacer forming a cell pair exhibiting an electrical conductivity at least 20% higher than the conductivity of a cell pair including the dilute spacer and concentrate spacer each including only anion exchange resin beads with uniform sizes and cation exchange resin beads with uniform sizes.

38. The electrochemical device of claim 30, wherein the second plurality of flow channels change in height with distance from the second inlet port at a same rate as the first plurality of flow channels change in height with distance from the first inlet port.

39. The electrochemical device of any one of claims 25-38, comprising an electrodeionization device, wherein the first plurality of first flow channels includes beads of anion and cation ion exchange resin each having a bimodal size distribution.

40. An electrochemical device including a spacer comprising:
an inlet port;
an outlet port;
a first plurality of flow channels configured to direct fluid from the inlet port to the outlet port;
a second plurality of flow channels configured to direct fluid from the inlet port to the outlet port; and
a mixing zone disposed fluidically between the first plurality of flow channels and the second plurality of flow channels, the mixing zone configured to receive fluid from each of the first plurality of flow channels and direct the fluid into each of the second plurality of flow channels.

41. The electrochemical device of claim 40, wherein the mixing zone includes a wall disposed between the first plurality of flow channels and second plurality of flow channels, the wall having a plurality of apertures configured to facilitate mixing of fluid in the mixing chamber.

42. The electrochemical device of claim 41, wherein the wall defines downstream ends of the first plurality of flow chambers.

43. The electrochemical device of claim 42, wherein the first plurality of flow channels includes beads of ion exchange resin and the plurality of apertures have dimensions smaller than the beads of ion exchange resin.

44. The electrochemical device of any one of claims 40-43, wherein the mixing chamber includes internal structures configured to promote mixing of fluid introduced into the mixing chamber from the first plurality of flow channels.

45. The electrochemical device of claim 40, wherein the mixing chamber further includes a second wall disposed between the first plurality of flow channels and second plurality of flow channels, the second wall having a second plurality of apertures.

46. The electrochemical device of claim 45, wherein the second wall defines upstream ends of the second plurality of fluid channels.

47. The electrochemical device of claim 46, wherein the second plurality of flow channels includes beads of ion exchange resin and the second plurality of apertures have dimensions smaller than the beads of ion exchange resin.

48. The electrochemical device of claim 40, wherein the first plurality of flow channels and the second plurality of flow channels are equal in number.

49. The electrochemical device of claim 40, wherein each of the first plurality of flow channels is aligned with a corresponding one of the second plurality of flow channels.

50. The electrochemical device of claim 40, wherein the first plurality of flow channels and the second plurality of flow channels have substantially same dimensions.

51. The electrochemical device of claim 40, wherein a direction of fluid flow through the first plurality of flow channels is substantially parallel to a direction of fluid flow through the second plurality of flow channels.

52. The electrochemical device of claim 40, wherein a velocity of fluid flow through the first plurality of flow channels is substantially the same as a velocity of fluid flow through the second plurality of flow channels.

53. The electrochemical device of claim 40, wherein the mixing zone has a width in an average direction of fluid flow through the mixing zone that is less than widths of the first plurality of flow channels in a direction perpendicular to an average direction of fluid flow through the first plurality of flow channels.

54. The electrochemical device of claim 53, wherein the width of the mixing zone is substantially constant across a length of the mixing zone.

55. The electrochemical device of claim 53, wherein the length of the mixing zone is substantially constant across a width of the mixing zone.

56. The electrochemical device of claim 40, wherein the mixing zone has a length in a direction perpendicular to an average direction of fluid flow through the mixing zone that is greater than lengths of the first plurality of flow channels in an average direction of fluid flow through the first plurality of flow channels.

57. The electrochemical device of claim 40, comprising and electrodeionization device, wherein the first plurality of flow channels includes beads of anion and cation ion exchange resin having a different average size than beads of anion and cation ion exchange resin included in the second plurality of flow channels.

58. The electrochemical device of claim 57, wherein the first plurality of flow channels includes beads of anion and cation ion exchange resin each having a unimodal size distribution.

59. The electrochemical device of claim 57, wherein the second plurality of flow channels includes beads of anion and cation ion exchange resin each having a bimodal size distribution.

60. An electrodeionization device including a spacer comprising:
an inlet port;
an outlet port;
a first plurality of flow channels configured to direct fluid from the inlet port to the outlet port;
a second plurality of flow channels configured to direct fluid from the inlet port to the outlet port, and being one of:
in series with the first plurality of flow channels, or
configured to flow fluid in an opposite direction from a direction of fluid flow through the first plurality of flow channels; and
ion exchange media beads disposed within each of the first plurality of flow channels and the second plurality of flow channels, a size distribution of the ion exchange media beads changing one of:
from an inlet to an outlet of the first plurality of flow channels,
from an inlet to an outlet of the second plurality of flow channels, or
from the first plurality of flow channels to the second plurality of flow channels.

61. The electrodeionization device of claim 60, wherein the ion exchange media beads include cation exchange media beads and anion exchange media beads.

62. The electrodeionization device of claim 61, wherein the cation exchange media beads have a different size distribution than the anion exchange media beads.

63. The electrodeionization device of claim 62, wherein the first plurality of flow channels or the second plurality of flow channels includes different number ratios of the cation exchange media beads to the anion exchange media beads.

64. The electrodeionization device of claim 62, wherein one of the first plurality of flow channels or the second plurality of flow channels includes a substantially same total surface area of the cation exchange media beads and the anion exchange media beads.

65. The electrodeionization device of claim 62, wherein one of the first plurality of flow channels or the second plurality of flow channels includes cation exchange media beads having a first packing density and anion exchange media beads having a second packing density different from the first packing density.

66. The electrodeionization device of claim 62, wherein one of the first plurality of flow channels or the second plurality of flow channels includes cation exchange media beads having a first unimodal size distribution with a first median size and anion exchange media beads having a second unimodal size distribution with a second median size different from the first median size.

67. The electrodeionization device of claim 61, wherein one of the cation exchange media beads or the anion exchange media beads have a bimodal size distribution.

68. The electrodeionization device of claim 67, wherein the cation exchange media beads and the anion exchange media beads collectively increase in volume during use of the electrodeionization device as compared to when initially packed into the first and second plurality of flow channels and decrease a void volume within the first and second plurality of flow channels by at least 5%.

69. The electrodeionization device of claim 67, wherein the cation exchange media beads include larger beads having substantially same sizes and smaller beads having substantially same sizes.

70. The electrodeionization device of claim 60, wherein the first and second pluralities of flow channels are arranged in series and an average size of the ion exchange media beads decreases with distance along a flow path through the first and second pluralities of flow channels.

71. The electrodeionization device of claim 70, wherein the second plurality of flow channels are disposed downstream of the first plurality of flow channels and an average size of the ion exchange media beads is smaller in the second plurality of flow channels than in the first plurality of flow channels.

72. The electrodeionization device of claim 71, wherein an average size of the ion exchange media beads decreases with distance along a flow path through one of the first plurality of flow channels or the second plurality of flow channels.

73. The electrodeionization device of claim 60, wherein a packing density of the ion exchange media beads changes one of:
from an inlet to an outlet of the first plurality of flow channels,
from an inlet to an outlet of the second plurality of flow channels, or
from the first plurality of flow channels to the second plurality of flow channels.

74. The electrodeionization device of claim 60, wherein a packing density of the ion exchange media beads is higher proximate walls than proximate central regions of one of the first plurality of flow channels or the second plurality of flow channels.

75. The electrodeionization device of claim 62, wherein one of the first plurality of flow channels or the second plurality of flow channels includes a layered bed of ion exchange resin including a layer of cation ion exchange resin, a layer of anion exchange resin, and a layer of mixed anion and cation ion exchange resin.

76. The electrochemical device of any of claims 1-59, further comprising a profiled ion exchange membrane disposed on one or both of upper or lower sides of the spacer.

77. The electrodeionization device of any of claims 60-75, further comprising a profiled ion exchange membrane disposed on one or both of upper or lower sides of the spacer.
